(19) United States
(12) Patent Application Publication
(10) Pub. No.: US 2025/0014803 A1
(43) Pub. Date: Jan. 9, 2025

(54) COIL COMPONENT, METHOD OF MANUFACTURING COIL COMPONENT, AND ELECTRONIC AND ELECTRIC DEVICES

(71) Applicant: Alps Alpine Co., Ltd., Ota-ku, Tokyo (JP)

(72) Inventors: Satoshi MARUYAMA, Niigata-ken (JP); Takeshi TAKAHASHI, Niigata-ken (JP); Kosuke CHIMATA, Niigata-ken (JP); Shuji IGUCHI, Niigata-ken (JP); Setsuko MARUYAMA, Niigata-ken (JP)

(21) Appl. No.: 18/741,034

(22) Filed: Jun. 12, 2024

(30) Foreign Application Priority Data
Jul. 3, 2023 (JP) 2023-109107

(51) Int. Cl. H01F 27/28; H01F 27/255; H01F 27/29; H01F 41/04

(52) U.S. Cl. CPC H01F 27/2804; H01F 27/255; H01F 27/292; H01F 41/04; H01F 2027/2809

(57) ABSTRACT

A coil component includes a coil portion and a main body. The coil portion has a central axis along a first direction and a ring-shaped conductor with two electric ends. The main body includes magnetic powder and a binder, and covers the ring-shaped conductor with a first surface and a second surface arranged side by side in the first direction. The main body has a first region formed of a first material and a second region formed of a second material. The first region includes the first surface and a central region, where the entire outer edge of the central region is in contact with the inner circumferential surface of the ring-shaped conductor, while the second region includes at least part of the second surface. The first material is different from the second material in at least one property in the magnetic powder, the binder, and another component, if any.

### CLAIM OF PRIORITY

This application claims benefit of Japanese Patent Application No. 2023-109107 filed on Jul. 3, 2023, which is hereby incorporated by reference.

### BACKGROUND OF THE INVENTION

### 1. Field of the Invention

The present invention relates to a coil component, a method of manufacturing the coil component, and an electronic and electric device in which the coil component is mounted.

### 2. Description of the Related Art

A power inductor disclosed in the description of Japanese Unexamined Patent Application Publication (Translation of PCT Application) No. 2019-532519 has: a body including magnetic powder and a polymer; at least one base material provided in the body, at least one coil pattern being formed on at least one surface of the base material; and an insulation layer formed between the coil pattern and the body. The body includes at least one region in which the magnetic powder having a particle size different from that of the magnetic powder in a remaining region is distributed.

In a coil component structured so that a coil is buried in a main body, when a current is passed through the coil, a magnetic circuit is formed in the main body so that currents flow along the central axis of the coil on the inner circumferential side and outer circumferential side of the coil and also flow in directions crossing the central axis of the coil on the two button surface sides of the coil. It may be preferable for the magnetic property of the coil to differ between the inner circumferential side and bottom surface side of the coil in the main body. When a coil component is mounted on a substrate, a portion positioned on the bottom surface side of the coil in the main body faces the substrate or protrudes from the substrate. Therefore, it may preferable for the above portion to have electric properties and mechanical properties different from those of a portion positioned on the inner circumferential side of the coil in the main body.

### SUMMARY OF THE INVENTION

The present invention provides a coil component in which a main body has enhanced functions. The present invention also provides a method of manufacturing the coil component and an electronic and electric device in which the coil component is mounted.

A coil component, in an aspect of the present invention, provided to solve the above problem has: a coil portion that has a central axis along a first direction and also has a ring-shaped conductor having two electric ends; and a main body that covers the ring-shaped conductor with a first surface and a second surface, which are arranged side by side in the first direction, the main body including magnetic powder and a binder. The coil portion is exposed from surfaces of the main body at a first end face linked to one of the two electric ends of the ring-shaped conductor and a second end face linked to the other of the two electric ends of the ring-shaped conductor. The main body includes: a first region formed from a first material, the first region including the first surface and a central region, the entire outer edge of which is in contact with the inner circumferential surface of the ring-shaped conductor; and a second region formed from a second material, the second region including at least part of the second surface. The first material and second material differ from each other at least one selected from the group consisting of the composition of the magnetic powder, a shape distribution, which is a distribution about the shape of the magnetic powder, the content of the magnetic powder, the composition of the binder, the content of the binder, the composition and content of a third component, which is a component other than the magnetic powder and binder, if the third component is included. With the coil component described above, a difference can be made between the material of the first region including the central region and the material of the second region including at least part of the second surface. Thus, it is possible for the main body to have new functions, enabling the main body to be enhanced in functionality.

Since, with the coil component described above, a difference can be made between the material of the first region including the central region and the material positioned in the vicinity of the second surface, it is possible for the main body to have various properties.

In the coil component described above, the second material may be more insulative than the first material. In this case, a short-circuit or dielectric breakdown is less likely to occur on the same side as the second surface, on which the second region is positioned.

The coil component described above may further have a first outside electrode and a second outside electrode, which are provided on the main body so as to be distant from each other, the first outside electrode being electrically connected to the first end face, the second outside electrode being electrically connected to the second end face. In this case, the first outside electrode may have a first covering portion that covers one part of the second surface, and the second outside electrode may have a second covering portion that covers another part of the second surface. Furthermore, the second region may have a first opposing portion facing the first covering portion, and may also have a second opposing portion facing the second covering portion. Even when at least part of the outside electrode is positioned on the second surface, a short-circuit or dielectric breakdown is less likely to occur.

In the coil component described above, the first end face may have a first exposed surface that is exposed on the second surface from the main body and is in contact with the first outside electrode, and the second end face may have a second exposed surface that is exposed on the second surface from the main body and is in contact with the second outside electrode. Even when the end of the coil component is positioned on the same side as the mounting surface, a short-circuit is less likely to occur between the outside electrodes.

In the coil component described above, the second region may have a contiguous portion, which is contiguous to both the first opposing portion and the second opposing portion and includes part of the second surface.

In the coil component described above, the second region may have a higher specific resistance than the first region. Since the specific resistance of the second region is relatively high, the possibility that a dielectric breakdown occurs is reduced at a portion positioned between the conductor having the first exposed surface and the conductor having the second t exposed surface.

In the coil component described above, the magnetic powder may include metal magnetic powder, and the second region may have a smaller relative permeability than the first region. A means for relatively increasing the insulation property of the second region is to increase the content of the insulative material in the second material. In this case, the content of the metal magnetic powder is relatively lowered, so the relative permeability of the second region is likely to become smaller than the relative permeability of the first region. In this case, a second distance between the second surface and an end of the coil portion, the end being close to the second surface in the first direction may be larger than a first distance between the first surface and an end of the coil portion, the end being close to the first surface in the first direction. Even when the second region has a smaller relative permeability than the first region, if the second distance is larger than the first distance, it is possible to prevent the magneto-resistance of the second region from becoming excessively high.

In the main body described above, the ring-shaped conductor may be in contact with the first region at an end in the first direction on the same side as the second surface. Since the first material is not present between the ring-shaped conductor and the first region, it may be possible to more stably enjoy advantages, such as suppression of a dielectric breakdown, obtained when the second region is provided.

As another aspect, the present invention provides a method of manufacturing a coil component that has: a coil portion that has a central axis in a first direction and also has a ring-shaped conductor having two electric ends; and a main body that covers the ring-shaped conductor with a first surface and a second surface, which are arranged side by side in the first direction, the main body including magnetic powder. The manufacturing method includes: placing a laminated body in a cavity in a die, the laminated body being composed of the coil component, a first member, at least part of which is positioned on one side of the coil component in the first direction, the first member including first magnetic powder and a first curable/curing material, and a second member positioned on another side of the coil component in the first direction, the second member including second magnetic powder and a second curable/curing material; and raising pressure in the cavity. Thus, a press-molded body composed of the coil component and the main body is obtained from the laminated body. In the press-molded body, a central region, the entire outer edge of which is in contact with the inner circumferential surface of the ring-shaped conductor, is formed from a material based on the first material.

In the above manufacturing method, the first member and the second member may differ from each other in at least one selected from the group consisting of: the composition of the first magnetic powder and the composition of the second magnetic powder; a particle diameter distribution of the first magnetic powder and a particle diameter distribution of the second magnetic powder; the content of the first magnetic powder in the first member and the content of the second magnetic powder in the second member; the composition of the first curable/curing material and the composition of the second curable/curing material; the content of the first curable/curing material in the first member and the content of the second curable/curing material in the second member; and the composition of a first additive component other than the first curable/curing material and first magnetic powder and the composition of a second additive component other than the second curable/curing material and second magnetic powder if the first member includes the first additive component and the second member includes the second additive component.

In this description, the curable/curing material includes a material to be cured and a curing material (such as a polymerization initiator) that performs curing. The additive component, which is not a ferromagnetic material, does not react with any curable/curing material. Examples of the additive component include a non-polymerizable material used to soften a member and inorganic particles used to enhance insulation.

The manufacturing method described above may further include curing the first curable/curing material and the second curable/curing material. In this case, a second material body formed by including the curing of the second curable/curing material in the second member may be more insulative than a first material body formed by the including curing of the first curable/curing material in the first member.

Furthermore, the coil component may have a first connection conductor linked to one of two electric ends of the ring-shaped conductor, and may also have a second connection conductor linked to the other of the two electric ends of the ring-shaped conductor. In this case, the first connection conductor may be exposed on the first end face from the second surface, the second connection conductor may be exposed on the second end face from the second surface, and the first connection conductor and the second connection conductor may each have a portion to be buried in the second material body in the press-molded body.

As yet another aspect, the present invention provides an electronic device and electric device in which the coil component described above is mounted, the coil component being connected to a substrate through terminals provided on exposed conductors, which are positioned at two ends of the coil portion, one at each end, so as to be exposed to the outside. Examples of this type of electronic device and electric device include a power supply and a small mobile communication device that have a power supply switching circuit, a step-up/down circuit, a smoothing circuit, or the like. Since the electronic device and electric device in the present invention has the coil component described above, the electronic device and electric device have superior comprehensive properties as an inductance element.

The present invention enables a main body in a coil component to have new functions such as a function for assuring insulation for outside electrodes, a function for suppressing a short-circuit in a coil portion, a function for positioning the coil portion in the main body, and a function for suppressing a deficit at the occurrence of a shock. These functions enable the main body to be enhanced in functionality, so a coil component superior in various properties including electric properties is provided. When this coil component is mounted in an electronic device or electric device, it is possible to improve the performance of the electronic device or electric device and to reduce the size of the electronic device or electric device. The present invention also provides an electronic device and electric device in which the coil component is mounted. Furthermore, the present invention provides a method of manufacturing the coil component described above.

### BRIEF DESCRIPTION OF THE DRAWINGS

FIG. 1 is a perspective view conceptually illustrating the shape of a coil component in an embodiment of the present invention;

FIG. 2 is an XZ sectional view along line II-II in FIG. 1;

FIG. 3 is an XY sectional view along line III-III in FIG. 2;

FIG. 4 illustrates distributions of magnetic powder with different shapes;

FIG. 5A illustrates an example of functions of a main body of a coil component in an embodiment of the present invention (comparative example);

FIG. 5B illustrates an example of functions of the main body of the coil component in an embodiment of the present invention (example of the present invention);

FIG. 5C illustrates distributions of magnetic powder with different shapes;

FIG. 6 is an XZ cross section illustrating a first variation of the coil component in an embodiment of the present invention;

FIG. 7 is an XZ cross section illustrating a second variation of the coil component in an embodiment of the present invention;

FIG. 8 is an XZ cross section illustrating a third variation of the coil component in an embodiment of the present invention;

FIG. 9 is an XZ cross section illustrating a fourth variation of the coil component in an embodiment of the present invention;

FIG. 10A illustrates a first example in an exemplary method of manufacturing the coil component in an embodiment of the present invention, as an XY plan view of a coil array sheet:

FIG. 10B is an XZ sectional view along line XB-XB in FIG. 10A;

FIG. 11 illustrates a second example in the exemplary method of manufacturing the coil component in an embodiment of the present invention, as an XZ sectional view illustrating a state in which the coil array sheet and the like are placed;

FIG. 12 illustrates a third example in the exemplary method of manufacturing the coil component in an embodiment of the present invention, as an XZ sectional view illustrating a state in which a press-molded body has been formed through press-molding in which a die was used;

FIG. 13 illustrates a fourth example in the exemplary method of manufacturing the coil component in an embodiment of the present invention, specifically illustrating a state before the press-molded body is cut;

FIG. 14 illustrates a fifth example of the exemplary method of manufacturing the coil component in an embodiment of the present invention, specifically illustrating a state in which coil chips have been obtained as a result of cutting the press-molded body;

FIG. 15 illustrates a first example of another exemplary method of manufacturing the coil component in an embodiment of the present invention; and

FIG. 16 illustrates a second example of the other exemplary method of manufacturing the coil component in an embodiment of the present invention.

### DESCRIPTION OF THE PREFERRED EMBODIMENTS

Embodiments of the present invention will be described below in detail with reference to the drawings.

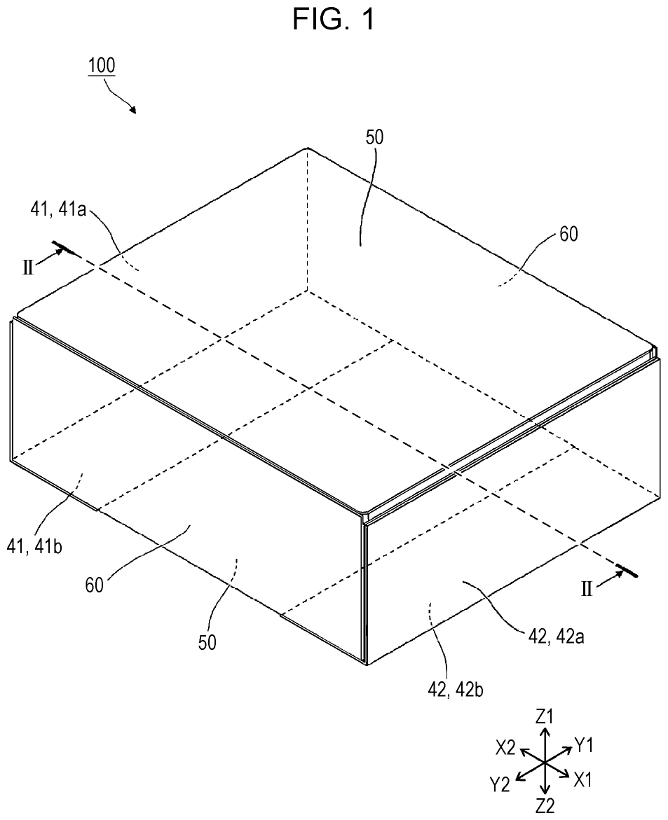

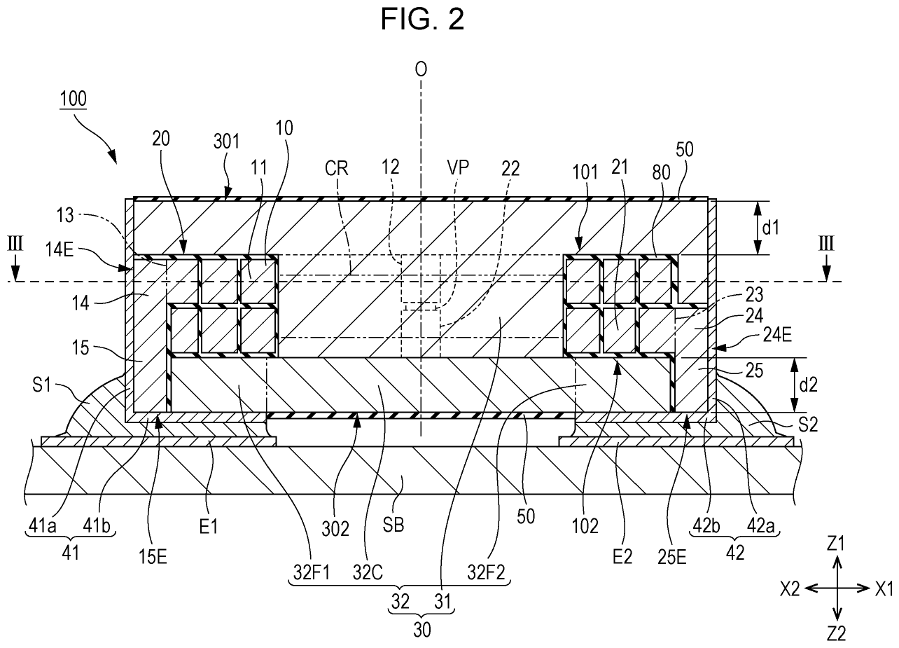

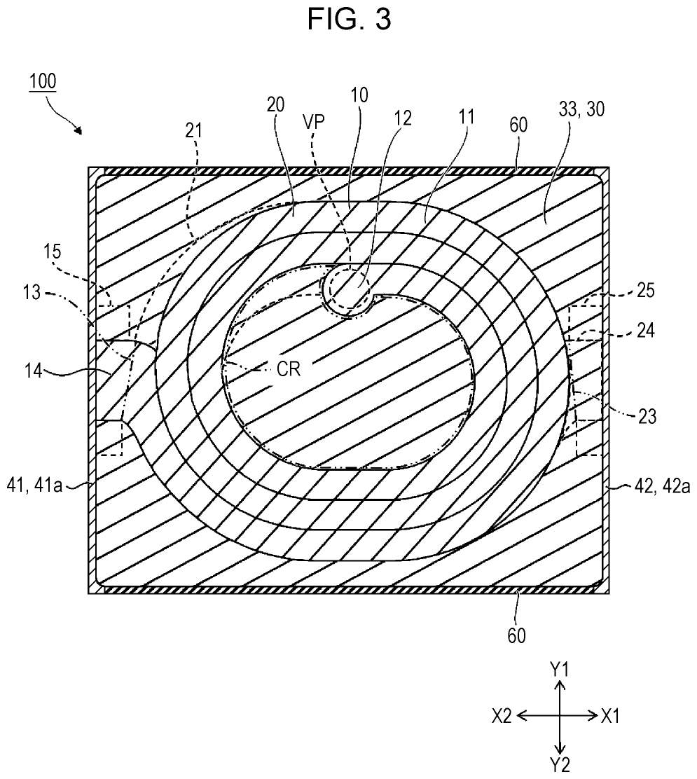

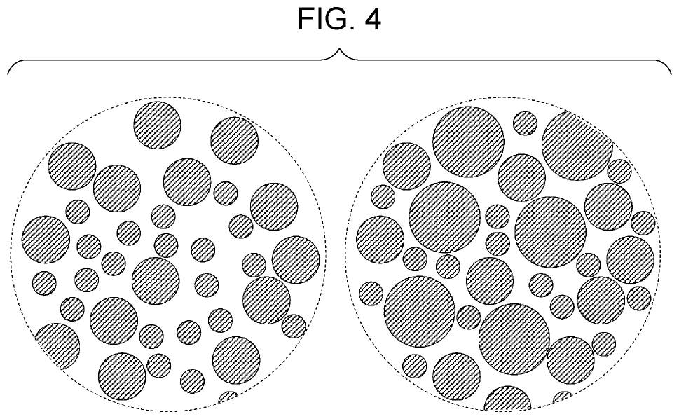

FIG. 1 is a perspective view conceptually illustrating the shape of a coil component in an embodiment of the present invention. FIG. 2 is an XZ sectional view along line II-II in FIG. 1. In FIG. 2, a state in which the coil component is bonded to a substrate is also illustrated for convenience of explanation. FIG. 3 is an XY sectional view along line III-III in FIG. 2. FIG. 4 illustrates distributions of magnetic powder with different shapes.

### <Entire Structure>

The coil component 100 in an embodiment of the present invention has a coil portion 10 having a coil conductor 20, a main body 30, a first outside electrode 41, a second outside electrode 42, and outer coats 50 and 60.

### Coil:

As illustrated in FIGS. 2 and 3, the coil portion 10 has the coil conductor 20, which has a first swirl conductor 11 in a swirl shape, around a central axis O along a first direction (Z1-Z2 direction). The first swirl conductor 11 is an example of part of a ring-shaped conductor. The first swirl conductor 11 has a swirl shape extending from an inner circumferential end 12, which is the end on the inner circumferential side of a pair of ends of the first swirl conductor 11, toward an outer circumferential end 13, which is the end on the outer circumferential side of the pair of ends of the first swirl conductor 11, so as to be away from the central axis O. With the first swirl conductor 11 in FIG. 3, a conductor is placed in a swirl state in which the conductor extends clockwise from the inner circumferential end 12 toward the outer circumferential end 13 so as to be away from the central axis O when viewed from the Z1 side in the Z1-Z2 direction. In this description, a swirl direction involved in a swirl portion indicates a direction from the end on the inner circumferential side toward the end on the outer circumferential side.

The coil conductor 20 has a second swirl conductor 21 placed side by side with the first swirl conductor 11 in the first direction. The second swirl conductor 21 is another example of part of the ring-shaped conductor. The second swirl conductor 21 has a swirl shape around the central axis O along the first direction (Z1-Z2 direction), the shape extending from one end (inner circumferential end 22), which is the end on the inner circumferential side of the second swirl conductor 21, toward another end (outer circumferential end 23), which is the end on the outer circumferential side of the second swirl conductor 21, so as to be away from the central axis O. With the second swirl conductor 21, a conductor is placed in a swirl state in which the conductor extends in a direction (in FIG. 3, a counterclockwise direction) opposite to the direction of the first swirl conductor 11 so as to be away from the central axis O when viewed from the Z1 side in the Z1-Z2 direction.

There is no particular restriction on the average value of the distance between the first swirl conductor 11 and the second swirl conductor 21 in the first direction (Z1-Z2 direction). The shorter the distance is, the easier it is to reduce the height of the coil component 100 (its dimension in the Z1-Z2 direction). However, if the distance is excessively short, insulation between the first swirl conductor 11 and the second swirl conductor 21 is likely to deteriorate. To achieve both a low profile of the coil component 100 and enhanced insulation between the first swirl conductor 11 and the second swirl conductor 21, the distance may be preferable 0.4 μm or more and 20 μm or less. From the viewpoint of manufacturing, the distance is more preferably 1.0 μm or more and further more preferably 5.0 μm or more so that, for example, variations in the distance are reduced and the coil is more reliably supported on the same surface.

There is no particular restriction on a conductor (conductive material) included in the coil conductor 20 if the conductor has an appropriate conductivity. Specific examples of the conductor included in the coil conductor 20 include copper materials, copper alloys, aluminum materials, aluminum alloys, and other metal materials. For example, a technology to form a film such as plating can be used to manufacture the coil conductor 20. The coil portion 10 has a coil insulating portion 80, which is insulative, on the surface of the coil conductor 20. This coil insulating portion 80 assures insulation between mutually adjacent conductors (between the surfaces of opposing conductors) in the coil conductor 20. The coil insulating portion 80 is not disposed on the terminal ends of two ends (first lead end 14E and second lead end 24E) of the coil conductor 20. At these terminal ends, therefore, the coil portion 10 can be electrically connected other members.

A via VP is used to electrically connect the inner circumferential end 12 of the first swirl conductor 11 and the inner circumferential end 22 of the second swirl conductor 21 together. When a portion connected to the via VP is taken as a start point, the first swirl conductor 11 and second swirl conductor 21 are swirled in opposite directions. The via VP may be a conductor similar to the conductor of the coil conductor 20. In a specific example, the via VP is manufactured together with the first swirl conductor 11 and second swirl conductor 21 in a process in which they are manufactured. In this case, the via VP is integrated with the inner circumferential end 12 of the first swirl conductor 11 and the inner circumferential end 22 of the second swirl conductor 21. In this embodiment, therefore, the ring-shaped conductor has the first swirl conductor 11, second swirl conductor 21, and via VP, and the outer circumferential ends 13 and 23 are two electric ends of the ring-shaped conductor.

A first lead 14 is linked to the outer circumferential end 13 of the first swirl conductor 11. A second lead 24 is linked to the outer circumferential end 23 of the second swirl conductor 21. Therefore, the outer circumferential end 13 of the first swirl conductor 11 is substantially an interface to the first lead 14, and the outer circumferential end 23 of the second swirl conductor 21 is substantially an interface to the second lead 24. In a specific example, the first lead 14 and second lead 24 are respectively manufactured together with first swirl conductor 11 and second swirl conductor 21 in a process in which they are manufactured. In this case, the first lead 14 has a portion integrated with the outer circumferential end 13 of the first swirl conductor 11 without an interface, and the second lead 24 has a portion integrated with the outer circumferential end 23 of the second swirl conductor 21 without an interface.

The coil component 100 in this embodiment has a first connection conductor 15 extending from the first lead 14 toward a second surface 302 (toward the Z2 side in the Z1-Z2 direction), and also has a second connection conductor 25 extending from the second lead 24 toward the second surface 302 (toward the Z2 side in the Z1-Z2 direction). At a first connection end 15E, the first connection conductor 15 may be exposed from the second surface 302 of the main body 30. At a second connection end 25E, the second connection conductor 25 may be exposed from the second surface 302 of the main body 30. That is, the first connection end 15E is a first exposed surface that is exposed on the second surface 302 from the main body 30 and is in contact with the first outside electrode 41, and the second connection end 25E is a second exposed surface that is exposed on the second surface 302 from the main body 30 and is in contact with the second outside electrode 42.

In this embodiment, the first swirl conductor 11, first lead 14, second swirl conductor 21, second lead 24, first connection conductor 15, second connection conductor 25, and via VP, which are included in the coil conductor 20, are manufactured so as to have an integrated portion in a common manufacturing process.

### Outer Electrodes

The coil component 100 in this embodiment has outer electrodes, which are provided on the outer side of the main body 30 as illustrated in FIG. 1, as terminals of the coil component 100. In other words, the outer electrodes are provided on exposed conductors, at which the coil portion 10 is exposed to the outside. Specifically, the outer electrodes are the first outside electrode 41 and second outside electrode 42.

More specifically, the first outside electrode 41 is composed of a first side-direction outer electrode 41a, which is positioned on an outer surface of the main body 30, and a first crossing-surface outer electrode 41b, which is positioned on the second surface 302 of the main body 30, the first side-direction outer electrode 41a and first crossing-surface outer electrode 41b being contiguous to each other. The first crossing-surface outer electrode 41b is a first covering portion, of the first outside electrode 41, that covers one part of the second surface 302. The first side-direction outer electrode 41a is electrically connected to the first lead end 14E. The first crossing-surface outer electrode 41b is electrically connected to the first connection end 15E. The second outside electrode 42 is composed of a second side-direction outside electrode 42a, which is positioned on another outer surface of the main body 30, and a second crossing-surface outside electrode 42b, which is positioned on the second surface 302 of the main body 30, the second side-direction outside electrode 42a and second crossing-surface outside electrode 42b being contiguous to each other. The second crossing-surface outside electrode 42b is a second covering portion, of the second outside electrode 42, that covers another part of the second surface 302. The second side-direction outside electrode 42a is electrically connected to the second lead end 24E. The second crossing-surface outside electrode 42b is electrically connected to the second connection end 25E.

When the first side-direction outer electrode 41a and second side-direction outside electrode 42a are provided, a solder S1 is positioned on a substrate SB between a first substrate electrode E1 and the first side-direction outer electrode 41a and between the first substrate electrode E1 and the first crossing-surface outer electrode 41b so as to extend in the X1-X2 direction from a position on the X2 side in the X1-X2 direction, the position being sufficiently distant from the first side-direction outer electrode 41a, to a position at which the solder S1 faces the second surface 302, as illustrated in FIG. 2. Similarly, a solder S2 is positioned on the substrate SB between a second substrate electrode E2 and the second side-direction outside electrode 42a and between the second substrate electrode E2 and the second crossing-surface outside electrode 42b so as to extend in the X1-X2 direction from a position on the X1 side in the X1-X2 direction, the position being sufficiently distant from the second side-direction outside electrode 42a, to a position at which the solder S2 faces the second surface 302. Thus, since the first substrate electrode E1 and second substrate electrode E2 are wide, stable electric connections are obtained between the first substrate electrode E1 and the first outside electrode 41 with the solder S1 intervening between them and between the second substrate electrode E2 and the second outside electrode 42 with the solder S2 intervening between them.

There is no particular restriction on the materials and structures of the first outside electrode 41 and second outside electrode 42 if they have appropriate conductivity. In a non-limiting example, the first outside electrode 41 and second outside electrode 42 are each a laminate including a Cu plating, a Ni plating, and a Sn plating in that order from a side close to the surface of the main body 30. The first outside electrode 41 and second outside electrode 42 may be a painted electrode in which a conductive material such as a silver material is dispersed in a resin or the like. Alternatively, the first outside electrode 41 and second outside electrode 42 may be each a combination of a plating and a painted electrode.

### Outer Coat

An outer coat 50, which is insulative, is provided on the upper surface (surface on the Z1 side in the Z1-Z2 direction) of the main body 30, as an insulating portion. Outer coats 60, which are insulative, are also provided on side surfaces of the main body 30, which are arranged side by side in the Y1-Y2 direction, as surface insulating portions. An insulative outer coat may also be provided on a portion, which is part of the bottom surface (surface on the Z2 side in the Z1-Z2 direction) of the main body 30 and on which the first crossing-surface outer electrode 41b and second crossing-surface outside electrode 42b are not disposed. Alternatively, the coil component 100 may lack the outer coats 50 and 60. The outer coats 50 and 60 may be formed at desired positions on the surfaces of the main body 30 according to the purpose. The outer coats 50 and 60 may include metal magnetic powder included in the main body 30. In this case, the area of the metal magnetic powder on the cross sections of the outer coats 50 and 60 may be preferably 50% or less of the area of the metal magnetic powder on the cross section of the main body 30.

### Coil Insulating Portion

Examples of the material of the coil insulating portion 80 include resin materials. However, the coil insulating portion 80 is not restricted to a particular material. The material may be an inorganic material or a mixture of an organic material and an inorganic material. The coil insulating portion 80 may be thermoplastic. Specific examples of the material of the coil insulating portion 80 include thermoplastic resin materials including a paraxylene polymer. Other examples of thermoplastic resins include a polyethylene resin, a polypropylene resin, a polyamide resin, a polyester resin, a polyamide-imide resin, a polyimide resin, a polysulfone resin, a polycarbonate resin, a liquid crystal polymer resin, a polyvinylidene fluoride resin, and a polytetrafluoro-ethylene resin. The coil insulating portion 80 only needs to be thermoplastic, as a whole, so the coil insulating portion 80 may include, for example, inorganic insulative particles, in addition to the above thermoplastic resin. Examples, other than the above thermoplastic resin materials, of the material of the coil insulating portion 80 are organic materials such as thermoplastic resins and inorganic materials such as oxides.

The coil insulating portion 80 is preferably superior in insulation. Specifically, its volume resistivity obtained according to the American Society for Testing and Materials (ASTM) D257 may be preferably 1.0×10¹⁴ Ω2 cm or more. This volume resistivity is more preferably 1.0×10¹⁵Ωcm or more and further more preferably 1.0×10¹⁶ Ω2 cm or more. There is no particular restriction on the upper limit of the volume resistivity. The volume resistivity may be 1.0×10²⁰Ωcm or less. The coil insulating portion 80 also preferably has a superior dielectric property. Specifically, its specific inductive capacity obtained according to the ASTM D150 at 60 Hz may be preferably 4.0 or less. This specific inductive capacity is more preferably 3.5 or less and is further more preferably 3.0 or less. There is no particular restriction on the lower limit of the specific inductive capacity. The specific inductive capacity may be 1.0 or more. There is no restriction on the methods of measuring the volume resistivity and specific inductive capacity of the coil insulating portion 80 if results equivalent to those obtained according to the above ASTM D257 and ASTM D150 can be expected. In an exemplary measurement method, a material, equivalent to the coil insulating portion 80, the dimensions of which have been adjusted to dimensions needed for measurement, is prepared separately as a measurement sample. The measurement sample is used to identify a constituent material through an analysis technique for component analysis, Fourier transform infrared spectroscopy (FT-IR), or the like, after which properties of the material such as volume resistivity are evaluated.

### Main Body

The main body 30 covers the first swirl conductor 11 and second swirl conductor 21 at least on a pair of crossing surfaces (first surface 301 and second surface 302) arranged side by side in the first direction (Z1-Z2 direction). The main body 30 includes magnetic powder and a binder. In this embodiment, the main body 30 has four outer surfaces, which extend in the first direction (Z1-Z2 direction), between the pair of crossing surfaces described above, forming a substantially rectangular parallelepiped shape. The main body 30 incorporates portions positioned at ends of the coil portion 10, other than the end faces of the first lead 14 at the outermost ends (end faces on the X2 side in the X1-X2 direction and on both sides in the Z1-Z2 direction) and the end faces of the second lead 24 at the outermost ends (end faces on the X1 side in the X1-X2 direction and on both sides in the Z1-Z2 direction).

The coil portion 10 is exposed from surfaces of the main body 30 at a first end face (first lead end 14E and first connection end 15E) linked to one (outer circumferential end 13) of the two electric ends of the ring-shaped conductor and a second end face (second lead end 24E and second connection end 25E) linked to the other (outer circumferential end 23) of the two electric ends of the ring-shaped conductor.

The main body 30 is composed of a first region 31 formed from a first material, the first region 31 including the first surface 301 and a second region 32 formed from a second material, the second region 32 including at least part of the second surface 302. The first region 31 includes a central region CR, the entire outer edge of which faces the inner circumferential surface of the ring-shaped conductor (first swirl conductor 11, second swirl conductor 21, and via VP). The length (thickness) of the central region CR in the first direction is appropriately set according to properties required by the central region CR, the shape of the inner circumferential side of the ring-shaped conductor, and the like. The thickness of the central region CR may be equivalent to the length of the ring-shaped conductor in the first direction (thickness of the ring-shaped conductor) or may be half of the thickness of the ring-shaped conductor. For example, the thickness of the central region CR may be one-fourth of the thickness of the ring-shaped conductor. When the central region CR has a smaller thickness than the ring-shaped conductor, the central region CR may be positioned so as to be offset toward the first surface 301 or toward the second surface 302 or may be positioned so as to be substantially evenly distant from the first surface 301 and second surface 302.

In this embodiment, the first material and second material differ from each other in at least one property selected from the group consisting of properties (i) through (vi) below:
(i) Composition of the magnetic powder;
(ii) Shape distribution, which is a distribution about the shape of the magnetic powder;
(iii) Content of the magnetic powder;
(iv) Composition of the binder;
(v) Content of the binder; and
(vi) Composition and content of a third component, which is a component other than the magnetic powder and binder, if the third component is included.

When the first material and second material are made to differ from each other in at least one property selected from the group, the first region 31 and second region 32 can have different properties in the main body 30. As a result, it may be possible for the main body 30 to have further functions.

In the main body 30, there is no particular restriction on a positional relationship between the boundary between the first region 31 and second region 32 arranged side by side in the first direction and an end of a portion in the first direction, in the coil portion 10, at which the ring-shaped conductor is positioned. For example, a portion, in the coil portion 10, that is composed of the ring-shaped conductor may be in contact with the second region 32 at an end in the first direction. In FIG. 2, an end, on the Z2 side in the Z1-Z2 direction, of a portion, in the coil portion 10, at which the second swirl conductor 21 (second end 102) is positioned is in contact with the second region 32. Thus, since another material (the first material, for example) is not present between the second region 32 and a portion, in the coil portion 10, that is composed of the ring-shaped conductor, it may be possible to more stably enjoy advantages, such as improved insulation, obtained when the second region 32 is provided.

### Magnetic Powder

Now, the magnetic powder will be described. The magnetic powder has a composition in which a magnetic body in the magnetic powder is formed from a conductive material or is formed from an insulating material.

A specific example of the conductive material is a metal material. When the magnetic powder is metal magnetic powder, there is no restriction on its crystallographical tissue. This tissue may include a crystalline phase or may include an amorphous phase. Here, a crystalline material will be defined as a material composed of a crystalline phase, an amorphous material will be defined as a material composed of an amorphous phase, and a mixed material will be defined as a material composed of a crystalline phase and an amorphous phase. When a diffraction spectrum obtained by an ordinary X-ray diffraction method includes sharp diffraction peaks by which the type of a crystalline phase can be identified, the material includes a crystalline phase. When a diffraction spectrum obtained by an ordinary X-ray diffraction method includes broad diffraction peaks indicating an amorphous phase, the material includes an amorphous phase. In a case as well in which a differential scanning calorimetry (DSC) curve obtained through differential thermal analysis includes peaks indicating crystallization, that is, indicates heat generation due to a change in phase from an amorphous phase to a crystalline phase, the material includes an amorphous phase.

There is no restriction on the material of the magnetic body. Specific examples of the crystalline material include Fe—Si—Cr alloys, Fe—Ni alloys, Fe—Co alloys, Fe—V alloys, Fe—Al alloys, Fe—Si alloys, Fe—Si—Al alloys, pure iron materials, and Mn—Zn ferrite materials. Carbonyl iron powder is preferable as pure ion powder. Specific examples of the amorphous material include Fe—Si—B alloys, Fe—P—C alloys, and Co—Fe—Si—B alloys. Specific examples of the mixed material include Fe—Zr alloys, Fe—Zr—B alloys, Fe—Nb—B alloys, Fe—Si—B—Nb—Cu alloys, and Fe—Si—B—P—Cu alloys. When the magnetic body includes Fe, a multiplier effect in the improvement of the magnetic property is particularly great.

There is no particular restriction on the chemical composition of the magnetic body. For example, a Fe—Si—Cr alloy may be composed of Si with a mass percent of 1.0% to 10.0%, Cr with a mass percent of 1.0% to 10.0%, and a residue composed of Fe and an impurity. For example, a Fe—Ni alloy may be composed of Ni with a mass percent of 1.0% to 99.0% and a residue composed of Fe and an impurity. For example, a Fe—P—C alloy may be composed of P with an atomic percent of 1.0% to 13.0%, C with an atomic percent of 1.0% to 13.0%, and a residue composed of Fe and an impurity. This type of Fe—P—C alloy may include one or more selected from the group consisting of Ni, Sn, Cr, B, and Si as arbitrary elements. In this case, the amount of Ni may be an atomic percent of 0% to 10.0%, the amount of Sn may be an atomic percent of 0% to 3.0%, the amount of Cr may be an atomic percent of 0% to 6.0%, the amount of B may be an atomic percent of 0% to 9.0%, and the amount of Si may be an atomic percent of 0% to 7.0%. The amount of Fe is preferably an atomic percent of 65% or more. For example, a Fe—Si—B—Nb—Cu alloy may be composed of Si with an atomic percent of 1.0% to 16.0%, B with an atomic percent of 1.0% to 15.0%, Nb with an atomic percent of 0.50% to 5.0%, Cu with an atomic percent of 0.50% to 5.0%, and a residue composed of Fe and an impurity. In this case, the amount of Fe is preferably an atomic percent of 65% or more.

When the magnetic body in the magnetic powder is formed from an insulative material, a specific example of it is a Ni—Zn ferrite material.

Surface insulation treatment may be performed on the magnetic powder. The magnetic powder on which surface insulation treatment has been performed improves the insulation resistance of the main body 30. There is no restriction on the type of surface insulation treatment on the magnetic powder. Examples of surface insulation treatment include phosphoric acid treatment, phosphating, and oxidation treatment. Magnetic powder may have an insulating film on the magnetic particle. This type of insulating film may include at least one selected from the group consisting of Si, P, and B as well as O (oxygen).

The magnetic powder may be a mixed material in which a plurality of powder materials are mixed. This type of magnetic powder is preferably a ferromagnetic material, and more preferably a soft magnetic material.

Shape distributions, which are distributions about the shape of the magnetic powder, include distributions about the shape of the magnetic powder itself (spherical shape, spicula shape, indefinite shape, or the like) and distributions about particle diameters. The range of particle diameters of the magnetic powder is, for example, 0.10 μm to 50.0 μm. A specific example of distributions about particle diameters is a volume granularity distribution obtained by performing particle size measurement on the magnetic powder in a laser diffraction or dispersion method. Another example is a distribution of the average equivalent circle diameter of the magnetic powder, the distribution being obtained by analyzing an image (secondary electronic image) resulting from taking a picture of a cross section of the main body 30 with a scanning electron microscope.

### Binder

In the main body 30, the binder included in the second region 32 may include a second polymer and the binder included in the first region 31 may include a first polymer. The physical property of a polymer can be easily adjusted by adjusting the composition of a monomer and the degree of polymerization. Therefore, when the binder includes a polymer, the property of the binder can be easily adjusted. Examples of polymers include an acrylic resin, a silicone resin, an epoxy resin, a phenol resin, a urea resin, a melamine resin, and a polyester resin. The binder may include an inorganic material, a specific example of which is a glass material such as liquid glass.

The second polymer may have a larger weight-average molecular weight than the first polymer. The insulation property and mechanical property of the second region 32, which includes a polymer with a relatively large molecular weight, is likely to be more greatly enhanced than the insulation property and mechanical property of the first region 31, as a whole. In this case, the difference in weight-average molecular weight between the second polymer and the first polymer may be 1% or more and 5% or less with respect to the weight-average molecular weight of the second polymer. It is possible to stably enjoy advantages obtained when the insulation property and mechanical property of the second region 32 are enhanced.

The second polymer may have a lower existence density of unreacted groups than the first polymer. Unreacted groups include active functional groups, such as a glycidyl group, an isocyanate group, and a carboxyl group, which easily react with other functional groups as well as functional groups having active hydrogen (such as a hydroxyl group and an amino group), which react with these active functional groups. When the polymer is formed by polymerization based on a radical polymerization catalyst, an ethylenically unsaturated bond may result in an unreacted group.

The insulation property and mechanical property of the second region 32, which includes a polymer in which the existence density of unreacted groups is relatively low, is likely to be more greatly enhanced than the insulation property and mechanical property of the first region 31, as a whole. In this case, the difference in the existence density of unreacted groups between the second polymer and the first polymer may be 1% or more and 5% or less with respect to the existence density of unreacted groups in the second polymer. It is possible to stably enjoy advantages obtained when the insulation property and mechanical property of the second region 32 are enhanced.

When the second material includes a polymerization catalyst used to form a binder and the first material also includes a polymerization catalyst used to form a binder, the content of the polymerization catalyst in the second material may be larger than the content of the polymerization catalyst in the first material. The polymerization catalyst is appropriately set according to the monomer used to form a polymer. Examples of the polymerization catalyst include urethane polymerization catalysts such as 2-(dimethylamino)-ethanol, epoxy polymerization catalysts such as tetrabutylphosphonium bromide, and olefin polymerization catalysts such as a metallocene compound. The second region 32 including a polymer in which the content of the polymerization catalyst is relatively large is likely to have a high strength and a high viscosity, as a whole. In this case, the difference in the content of the polymerization catalyst between the second material and the first material may be 1% or more and 5% or less with respect to the content of the polymerization catalyst in the second material. It is possible to stably enjoy advantages obtained when the insulation property and mechanical property of the second region 32 are enhanced.

The binder included in the second region 32 may have a lower hardness, measured with a nanoindenter, than the binder included in the first region 31. The insulation property and mechanical property of the second region 32 including a hard binder are likely to be more greatly enhanced than the insulation property and mechanical property of the first region 31, as a whole. In this case, the difference in hardness measured with a nanoindenter between the binder included in the second region 32 and the binder included in the first region 31 may be 1% or more and 5% or less with respect to the hardness, measured with a nanoindenter, of the binder included in the second region 32. It is possible to stably enjoy advantages obtained when the insulation property and mechanical property of the second region 32 are enhanced.

### Insulation Property

In the main body 30, the second material may be more insulative than the first material. In this case, another function that assures insulation from an outer electrode is given to the main body 30. When the second surface 302 is on the same side as the mounting side (the side facing the substrate SB) as illustrated in FIG. 2 and other drawings, a short-circuit is less likely to be formed on the mounting side. In particular, when lower-surface electrodes such as the first crossing-surface outer electrode 41b and second crossing-surface outside electrode 42b are disposed as in this embodiment, insulation between the lower-surface electrodes and the main body 30 is assured, so a short-circuit is less likely to be formed between the lower-surface electrodes.

As a means for making the second material more insulative than the first material, the second region 32 may have a higher specific resistance than the first region 31.

When the magnetic powder includes metal magnetic powder, the relative permeability u2 of the second region 32 may be preferably smaller than the relative permeability u1 of the first region 31, to stably assure that the second material is more insulative than the first material. When the magnetic powder that includes metal magnetic powder comes into contact with the metal magnetic powder in the main body 30, the possibility becomes higher that a conductive path, which degrades the insulation property, is formed. A means for relatively enhancing the insulation property of the second region 32 is to increase the content of the insulative material in the second material. In this case, since the content of the metal magnetic powder is lowered, the relative permeability u2 of the second region 32 is likely to become smaller than the relative permeability u1 of the first region 31.

In this case, a distance d2 between the second surface 302 and an end of the coil portion 10, the end being close to the second surface 302, that is, the second end 102, in the first direction may be larger than a distance d1 between the first surface 301 and an end of the coil portion 10, the end being close to the first surface 301, that is, a first end 101, in the first direction. Even when the relative permeability u2 of the second region 32 is smaller than the relative permeability u1 of the first region 31, if d2 is larger than d1, it is possible to prevent the magneto-resistance of the second region 32 from becoming excessively high.

When u2 is smaller than u1 as described above, equation (1) below may be satisfied. When equation (1) is satisfied, the magneto-resistance of the second region 32 is less likely to become excessively high. This stably prevents the magnetic property of the coil component 100 from being degraded.

$$μ1 \times d 1 - μ2 \times d 2 \vert / ( μ1 \times d 1 ) \leq 0.1 \qquad ( 1 )$$

To stably assure that the second material is more insulative than the first material when the magnetic powder includes metal magnetic powder, at least one of condition (A) and condition (B) below may be satisfied as for a first cross section and a second cross section, the first cross section being obtained by cutting the first region 31 on an XY plane orthogonal to the first direction, the second cross section being obtained by cutting the second region 32 on an XY plane orthogonal to the first direction.
(A) A second area ratio, which is the area ratio of the magnetic powder on the second cross section, is lower than a first area ratio, which is the area ratio of the magnetic powder on the first cross section.
(B) A second average equivalent circle diameter, which is the average equivalent circle diameter of the magnetic powder on the second cross section, is larger than a first average equivalent circle diameter, which is the average equivalent circle diameter of the magnetic powder on the first cross section.

As for condition (A), when the second area ratio is smaller than the first area ratio, u2 is likely to be made smaller than u1. In this case, since the area ratio of the binder is higher in the second region 32, the second region 32 is likely to become more insulative. An example in FIG. 4 will be described below. FIG. 4 illustrates distributions of magnetic powder with different shapes. The drawing on the left corresponds to an image observed on the first cross section. The drawing on the right corresponds to an image observed on the second cross section. In the region of each dotted circle, the cross section of the magnetic powder is hatched, and the cross section of the binder and other materials (matrix) other than the magnetic powder is colorless. A specific example of the binder is a polymer as described later. In this case, the magnetic powder, which is metal magnetic powder, is less insulative than the matrix. Therefore, condition (A) is satisfied when the cross section illustrated in the left drawing, in which the area ratio of the magnetic powder is relatively low, of the two drawings in FIG. 4 is the second cross section, and the cross section in the right drawing is the first cross section.

As for condition (B), when the average equivalent circle diameter of the magnetic powder is relatively large, the filling ratio is likely to be lowered. Therefore, when the second average equivalent circle diameter is larger than the first average equivalent circle diameter, u2 is likely to be made smaller than u1. In this case, since the area ratio of the binder is likely to become higher in the second region 32, the specific resistance of the second region 32 is likely to become high.

To stably assure that the second material is more insulative than the first material, the second material may include insulative inorganic particles as a third component. The material of insulative inorganic particles is often superior in dielectric strength to the binder. This tendency is noticeable when the binder is a polymer. When inorganic particles are included as the third component of the second material, it is possible to reduce the possibility that a dielectric breakdown occurs in the second region 32. There is no restriction on the type of inorganic particle. Oxide inorganic particles formed from silica, alumina, zirconia, or the like may be preferable because of ease of availability.

To stably assure that the second material is more insulative than the first material, the magnetic powder included in the second region 32 may include metal magnetic powder having an insulating film on the surface. When the magnetic powder is metal magnetic powder, the magnetic powder forms a conductive path at the occurrence of a dielectric breakdown. However, when the metal magnetic powder has an insulating film on the surface, it may be possible to reduce the possibility that a dielectric breakdown occurs in the second region 32.

### Prevention of a Short-Circuit in the Coil Portion

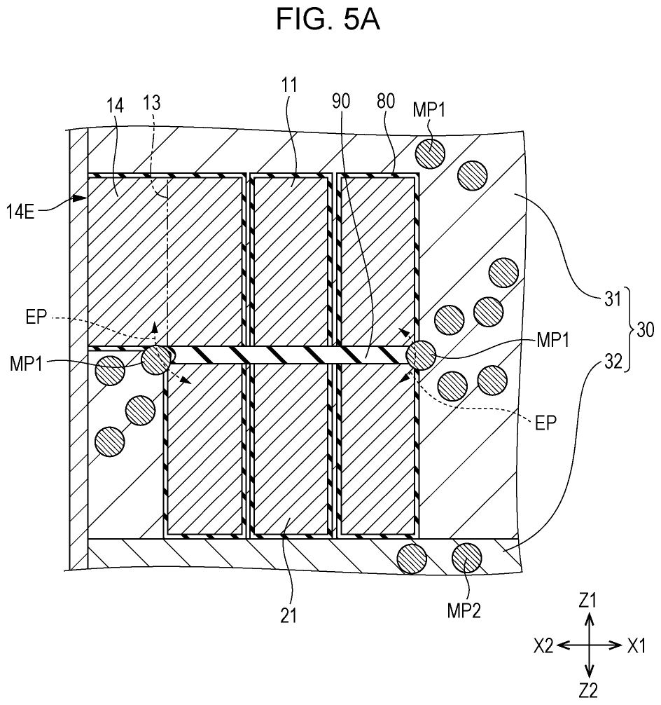

FIG. 5A illustrates an example of functions of the main body 30 of the coil component 100 in an embodiment of the present invention (comparative example). FIG. 5B illustrates an example of functions of the main body 30 of the coil component 100 in an embodiment of the present invention (example of the present invention). FIG. 5C illustrates distributions of magnetic powder with different shapes.

As illustrated in FIG. 5A, the coil insulating portion 80 is disposed around the first swirl conductor 11 and second swirl conductor 21, preventing a short-circuit between turns of the same swirl conductor. An interposer 90, which is insulative, is placed as an insulating portion between the first swirl conductor 11 and the second swirl conductor 21. This also prevents a short-circuit between a turn of the first swirl conductor 11 and a turn of the second swirl conductor 21, these turns being arranged side by side in the first direction.

However, when magnetic powder MP1 included in the first material from which the first region 31 is formed includes metal magnetic powder, if the particle diameter of the magnetic powder MP1 is larger than the thickness of the interposer 90, it is feared that the magnetic powder MP1 is positioned so as to form a short-circuit path EP between a turn of the first swirl conductor 11 and a turn of the second swirl conductor 21 as illustrated in FIG. 5A. A similar short-circuit problem may occur between the first lead 14 and a turn of the second swirl conductor 21 and between the second lead 24 and a turn of the first swirl conductor 11. When a material including the magnetic powder MP1 is placed around the coil portion 10 and is then pressurized to form the main body 30, the magnetic powder MP1 may come into contact with the conductor of the coil portion 10 while the magnetic powder MP1 partially destroys the insulating portion (coil insulating portion 80 and interposer 90) of the coil portion 10. At that time, the above short-circuit problem is highly likely to occur.

In view of this, a new function for suppressing a short-circuit in the coil portion 10 is given to the main body 30 by making the shape distribution of the magnetic powder MP1 included in the first material different from the shape distribution of the magnetic powder MP2 included in the second material. In FIG. 5B, metal magnetic powder having a smaller particle diameter than the magnetic powder MP2 included in the second material is used as the magnetic powder MP1 included in the first material. Therefore, even if the magnetic powder MP1 comes into contact with the conductor of the coil portion 10 while the magnetic powder MP1 partially destroys the insulating portion (coil insulating portion 80 and interposer 90) of the coil portion 10, a short-circuit is less likely to occur.

There is no restriction on the material from which to form the interposer 90 if the material has appropriately insulative. The volume resistivity, obtained according to the ASTM D257, of the interposer 90 may be preferably 1.0×10¹⁴Ωcm or more. This volume resistivity is more preferably 1.0×10¹⁵ Ω2 cm or more and further more preferably 1.0×10¹⁶Ωcm or more. There is no particular restriction on the upper limit of the volume resistivity. The volume resistivity may be 1.0×10²⁰Ωcm or less. The interposer 90 also preferably has a superior dielectric property. Specifically, its specific inductive capacity obtained according to the ASTM D150 at 60 Hz may be preferably 4.0 or less. This specific inductive capacity is more preferably 3.5 or less and is further more preferably 3.0 or less. There is no particular restriction on the lower limit of the specific inductive capacity. The specific inductive capacity may be 1.0 or more. In the measurement of the volume resistivity and specific inductive capacity of the interposer 90, a separately prepared material, equivalent to the interposer 90, the dimensions of which has been adjusted to dimensions needed for measurement, is used. The material equivalent to the interposer 90 can be identified through, for example, an analysis technique for component analysis, FT-IR, or the like, as with the coil insulating portion 80.

The material from which to form the interposer 90 may be an organic material, an inorganic material, or a mixture of an organic material and an inorganic material. When the interposer 90 is formed from a mixed material, the inorganic material may have a particle shape and may be dispersed in a matrix formed from the organic material. Specific examples of the organic material include a polyamide resin, a polyethylene resin, a polypropylene resin, a polyamide resin, a polyester resin, a polyamide-imide resin, a polysulfone resin, a polycarbonate resin, a liquid crystal polymer resin, a polyvinylidene fluoride resin, and a polytetrafluoro-ethylene resin. Examples of the inorganic material, particularly the inorganic material in the mixed material, include inorganic materials of oxide, carbide, nitride, and inorganic salt. Examples of oxide include silica, alumina, and zirconia. An example of an inorganic material of carbide is an inorganic material of silicon carbide. An example of an inorganic material of nitride is an inorganic material of boron nitride. Examples of inorganic salt include wollastonite, kaoline, mica, and other minerals. Of these materials, oxide materials of oxide, silicate, and phosphate are preferable from the viewpoints of costs and insulation. For example, an inorganic material preferably includes at least one selected from the group consisting of silicon (Si), phosphorus (P), boron (B), and calcium (Ca).

To stably reduce the possibility that the above short-circuit problem occurs, it may be preferable to satisfy at least one of the conditions (a) through (d) listed below when a comparison is made for the shape distribution of the magnetic powder between the first cross section and the second cross section, the first cross section being obtained by cutting the first region 31 on a plane orthogonal to the first direction, the second cross section being obtained by cutting the second region 32 on a plane orthogonal to the first direction:
(a) The first average equivalent circle diameter, which is the average equivalent circle diameter of the magnetic powder MP1 on the first cross section, is smaller than the second average equivalent circle diameter, which is the average equivalent circle diameter of the magnetic powder MP2 on the second cross section;
(b) A first median diameter, which is the median diameter of the magnetic powder MP1 on the first cross section, is smaller than a second median diameter, which is the median diameter of the magnetic powder MP2 on the second cross section;
(c) A first maximum equivalent circle diameter, which is the maximum equivalent circle diameter of the magnetic powder MP1 on the first cross section, is smaller than a second maximum equivalent circle diameter, which is the maximum equivalent circle diameter of the magnetic powder MP2 on the second cross section; and
(d) At least one of a second diameter distribution, which is a distribution of equivalent circle diameters of the magnetic powder MP2 on the second cross section, and a first diameter distribution, which is a distribution of equivalent circle diameters of the magnetic powder MP1 on the first cross section, has two or more peaks, wherein a first peak diameter, which is an equivalent circle diameter with the maximum frequency at the peak on the largest diameter side, the peak being one of the peaks included in the first diameter distribution, is smaller than a second peak diameter, which is an equivalent circle diameter with the maximum frequency at the peak on the largest diameter side, the peak being one of the peaks included in the second diameter distribution.

As for condition (a), the possibility that magnetic powder with relatively small particle diameters is present is higher in the first region 31. Therefore, when a material including the magnetic powder MP1 is pressurized in the formation of the main body 30, even if an insulating portion (coil insulating portion 80 and interposer 90) disposed on the surface of the ring-shaped conductor (first swirl conductor 11, second swirl conductor 21, and via VP) is locally broken by the magnetic powder MP1 during pressurization, a short-circuit is less likely to be formed in the ring-shaped conductor.

The difference between the first average equivalent circle diameter and the second average equivalent circle diameter may be preferably 1% or more and 5% or less with respect to the second average equivalent circle diameter. From the viewpoint of preventing a short-circuit in the ring-shaped conductor (first swirl conductor 11, second swirl conductor 21, and via VP), a smaller first average equivalent circle diameter is more preferable. However, when the average equivalent circle diameter is small, the filling ratio tends to rise. Therefore, when the first average equivalent circle diameter is excessively small, the filling ratio in the second region 32 becomes relatively low, so it is feared that the magneto-resistance of the second region 32 is increased. In the above range, however, it is possible to restrain the magneto-resistance of the second region 32 from becoming relatively too high while a short-circuit in the ring-shaped conductor is appropriately suppressed.

As for condition (b), the possibility that magnetic powder with relatively small particle diameters is present is higher in the first region 31. Therefore, when a material including the magnetic powder MP1 is pressurized in the formation of the main body 30, even if an insulating portion disposed on the surface of the ring-shaped conductor is locally broken by the magnetic powder MP1 during pressurization, a short-circuit is less likely to be formed in the ring-shaped conductor.

The difference between the first median diameter and the second median diameter may be 1% or more and 5% or less with respect to the second median diameter. From the viewpoint of preventing a short-circuit in the ring-shaped conductor, a smaller first median diameter is more preferable. However, when the median diameter is small, the filling ratio tends to rise. Therefore, when the first median diameter is excessively small, the filling ratio in the second region 32 becomes relatively low, so it is feared that the magneto-resistance of the second region 32 is increased. In the above range, however, it is possible to restrain the magneto-resistance of the second region 32 from becoming relatively too high while a short-circuit in the ring-shaped conductor is appropriately suppressed.

As for condition (c), the possibility that magnetic powder with relatively small particle diameters is present is higher in the first region 31. Therefore, when a material including the magnetic powder MP1 is pressurized in the formation of the main body 30, even if an insulating portion disposed on the surface of the ring-shaped conductor is locally broken by the magnetic powder MP1 during pressurization, a short-circuit is less likely to be formed in the ring-shaped conductor.

The difference between the first maximum equivalent circle diameter and the second maximum equivalent circle diameter may be preferably 1% or more and 5% or less with respect to the second maximum equivalent circle diameter. From the viewpoint of preventing a short-circuit in the ring-shaped conductor, a smaller first maximum equivalent circle diameter is more preferable. However, when the maximum equivalent circle diameter is small, the filling ratio tends to rise. Therefore, when the first maximum equivalent circle diameter is excessively small, the filling ratio in the second region 32 becomes relatively low, so it is feared that the magneto-resistance of the second region 32 is increased. In the above range, however, it is possible to restrain the magneto-resistance of the second region 32 from becoming relatively too high while a short-circuit in the ring-shaped conductor is appropriately suppressed.

The first maximum equivalent circle diameter may be preferably 2.0 μm or more and 10.0 μm or less, and the second maximum equivalent circle diameter may be preferably 12.0 μm or more and 50.0 μm or less. In these ranges, the possibility is high that the effect in which the magneto-resistance of the second region 32 becomes high can be suppressed while a short-circuit in the ring-shaped conductor is appropriately suppressed.

As for condition (d), the possibility that magnetic powder with relatively small particle diameters is present is higher in the first region 31. Therefore, when a material including the magnetic powder MP1 is pressurized in the formation of the main body 30, even if an insulating portion disposed on the surface of the ring-shaped conductor is locally broken by the magnetic powder MP1 during pressurization, a short-circuit is less likely to be formed in the ring-shaped conductor. Of the two equivalent circle diameter distributions illustrated in FIG. 5C, the distribution on the right side has two peaks. In a comparison of the peak on the largest diameter side of the peaks between the two distributions, the peak of the distribution on the right is larger. Therefore, of the two equivalent circle diameter distributions illustrated in FIG. 5C, the distribution on the left is an example of the first diameter distribution and the distribution on the right is an example of the second diameter distribution.

The difference between the first peak diameter and the second peak diameter may be preferably 1% or more and 5% or less with respect to the second peak diameter. From the viewpoint of preventing a short-circuit in the ring-shaped conductor, a smaller first peak diameter is more preferable. However, when the peak diameter is small, the filling ratio tends to rise. Therefore, when the first peak diameter is excessively small, the filling ratio in the second region 32 becomes relatively low, so it is feared that the magneto-resistance of the second region 32 is increased. In the above range, however, it is possible to restrain the magneto-resistance of the second region 32 from becoming relatively too high while a short-circuit in the ring-shaped conductor is appropriately suppressed.

It may be preferable for the second diameter distribution to have more peaks than the first diameter distribution. In the second region 32 in which magnetic powder with relatively large diameters is included, when magnetic powder with small diameters is included to the extent that peaks appear, the filling ratio of the magnetic powder MP2 can be easily increased and the magnetic property of the second region 32 is thereby likely to be enhanced. Of the two equivalent circle diameter distributions illustrated in FIG. 5C, the distribution on the right, which is an example of the second diameter distribution, has two peaks.

There may be the fear that the short-circuit described above occurs because the magnetic powder MP1 includes metal magnetic powder. In this case, to stably reduce the possibility that a short-circuit problem occur, it may be preferable for at least one of a first granularity distribution and a second granularity distribution to have two or more peaks, the first granularity distribution being a volume granularity distribution of the magnetic powder included in the first region 31, the second granularity distribution being a volume granularity distribution of the magnetic powder included in the second region 32. It may be also preferable for first granularity to be smaller than second granularity, the first granularity being the granularity with the maximum frequency at the peak on the largest diameter side, the peak being one of the peaks included in the first granularity distribution, the second granularity being the granularity with the maximum frequency at the peak on the largest diameter side, the peak being one of the peaks included in the second granularity distribution.

The possibility that magnetic powder with relatively small particle diameters is present is higher in the first region 31. Therefore, when a material including the magnetic powder MP1 is pressurized in the formation of the main body 30, even if an insulating portion disposed on the surface of the ring-shaped conductor is locally broken by the magnetic powder MP1 during pressurization, a short-circuit is less likely to be formed in the ring-shaped conductor.

The difference between the first granularity and the second granularity may be 1% or more and 5% or less with respect to the second granularity. From the viewpoint of preventing a short-circuit in the ring-shaped conductor, smaller first granularity is more preferable. However, when the granularity defined above is small, the filling ratio may tend to rise. Therefore, when the first granularity is excessively small, the filling ratio in the second region 32 becomes relatively low, so it may be feared that the magneto-resistance of the second region 32 is increased. In the above range, however, it is possible to restrain the magneto-resistance of the second region 32 from becoming relatively too high while a short-circuit in the ring-shaped conductor is appropriately suppressed.

It may be preferable for the second granularity distribution to have more peaks than the first granularity distribution. In the second region 32 in which magnetic powder with relatively large diameters is included, when magnetic powder with small diameters is included to the extent that peaks appear, the filling ratio of the magnetic powder MP2 can be easily increased and the magnetic property of the second region 32 is thereby likely to be enhanced.

### Mechanical Property

The second material may be harder than the first material. In most of the second region 32, the coil portion 10 is not present. Therefore, when the second region 32 is hardened, a problem due to deficit or deformation of the main body 30 is less likely to occur. When, in the formation of the main body 30, a material including magnetic powder and a curable/curing material is pressurized in the first direction as will be described later, the positioning of the coil portion 10 in the main body 30 can be easily controlled.

To stably assure that the second material is harder than the first material, the second area ratio may be preferably higher than the first area ratio, the second area ratio being the area ratio of the magnetic powder on the second cross section obtained by cutting the second region 32 on a plane orthogonal to the first direction, the first area ratio being the area ratio of the magnetic powder on the first cross section obtained by cutting the first region 31 on a plane orthogonal to the first direction.

To assure both that the second region 32 is harder and that the magnetic property and electrical property of the coil component 100 are appropriately kept with the suppression of the effect in which the magneto-resistance of the first region 31 is increased, the difference between the first area ratio and the second area ratio may be 1% or more and 5% or less with respect to the second area ratio.

### Variations

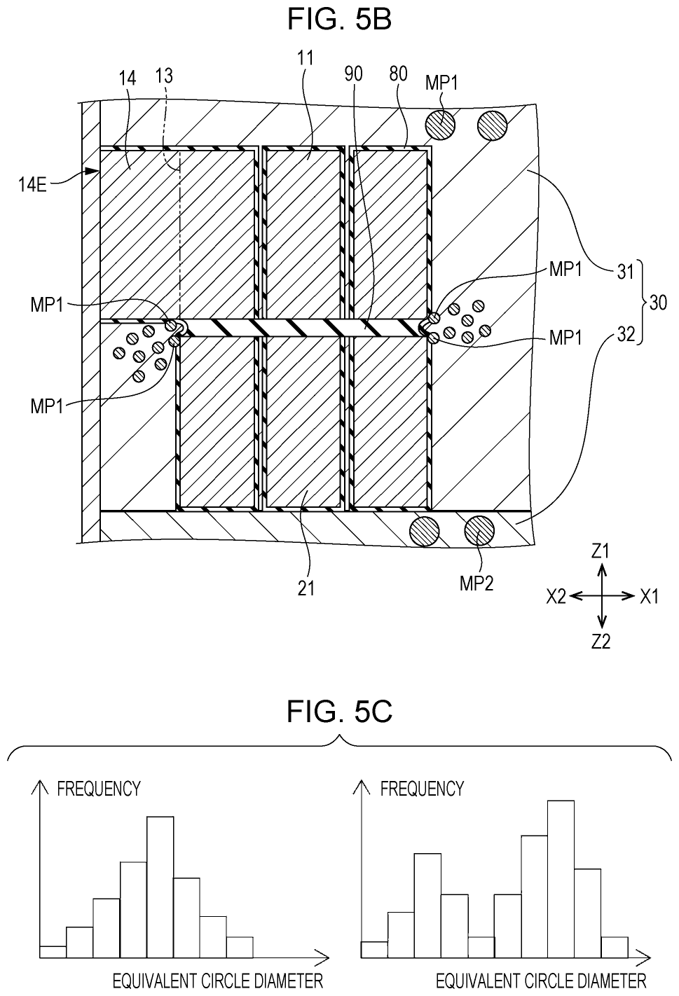

FIG. 6 is an XZ cross section illustrating a first variation of the coil component in an embodiment of the present invention. Basically, a coil component 100A, illustrated in FIG. 6, in one of the variations of an embodiment of the present invention has the same structure as the coil component 100. Therefore, only differences in the structure will be described, and descriptions of common points in the structure will be omitted. In the coil component 100A in this variation, an intermediate layer 33 formed from a mixed material of the first material and second material is present between the first region 31 and the second region 32. The intermediate layer 33 of this type is unavoidably formed in some manufacturing methods. The intermediate layer 33 may include an inclined region in which its composition changes in directions including the first direction. When the intermediate layer 33 of this type is included, it may be possible to prevent effects due to changes in property between regions, such as a local rise in magneto-resistance or local deterioration in mechanical property.

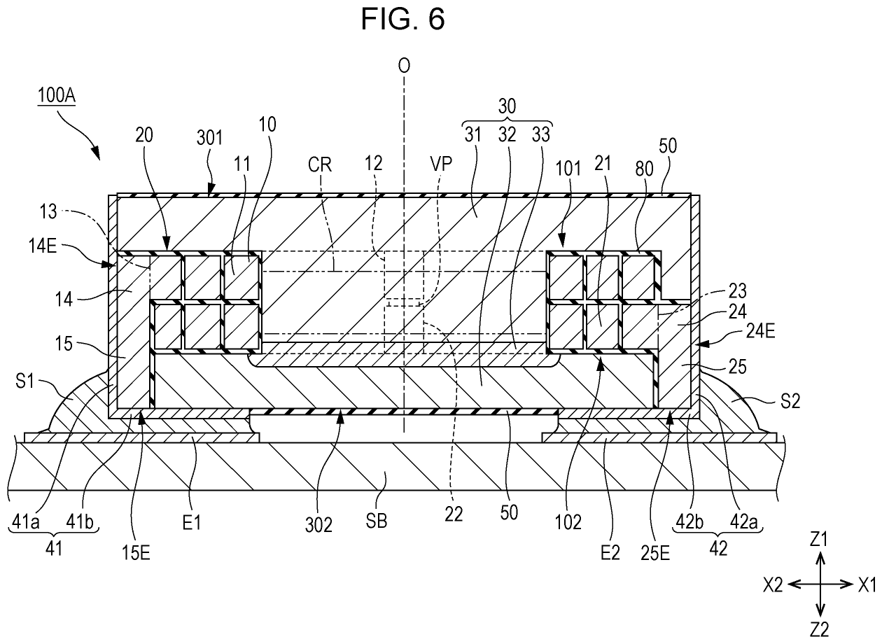

FIG. 7 is an XZ cross section illustrating a second variation of the coil component in an embodiment of the present invention. Basically, a coil component 100B, illustrated in FIG. 7, in one of the variations of an embodiment of the present invention has the same structure as the coil component 100. Therefore, only differences in the structure will be described, and descriptions of common points in the structure will be omitted. In the coil component 100 illustrated in FIG. 2 and other drawings, the second region 32 has included the whole of the second surface 302 of the main body 30. In contrast, in the coil component 100B in this variation, the second region 32 has a first opposing portion 32F1 facing the first crossing-surface outer electrode 41b corresponding to the first covering portion of the first outside electrode 41, and also has a second opposing portion 32F2 facing the second crossing-surface outside electrode 42b corresponding to the second covering portion of the second outside electrode 42. Thus, the second region 32 includes part of the second surface 302, and the first region 31 includes portions, of the second surface 302, that are not included in the second region 32. Since the first region 31 and second region 32 are allocated in this way, even if the second region 32 has trade-off functions (high insulation and low permeability), it is possible to obtain advantages resulting from providing the second region 32 and to suppress the effect caused by the second region 32 to a minimum.

When the coil component 100, illustrated in FIG. 2 and other drawings, which includes the whole of the second surface 302 of the main body 30, is considered in relation to the coil component 100B, the coil component 100 can be said to include the first opposing portion 32F1 and second opposing portion 32F2 and also have a contiguous portion 32C, which is contiguous to both the first opposing portion 32F1 and second opposing portion 32F2 and includes part of the second surface 302.

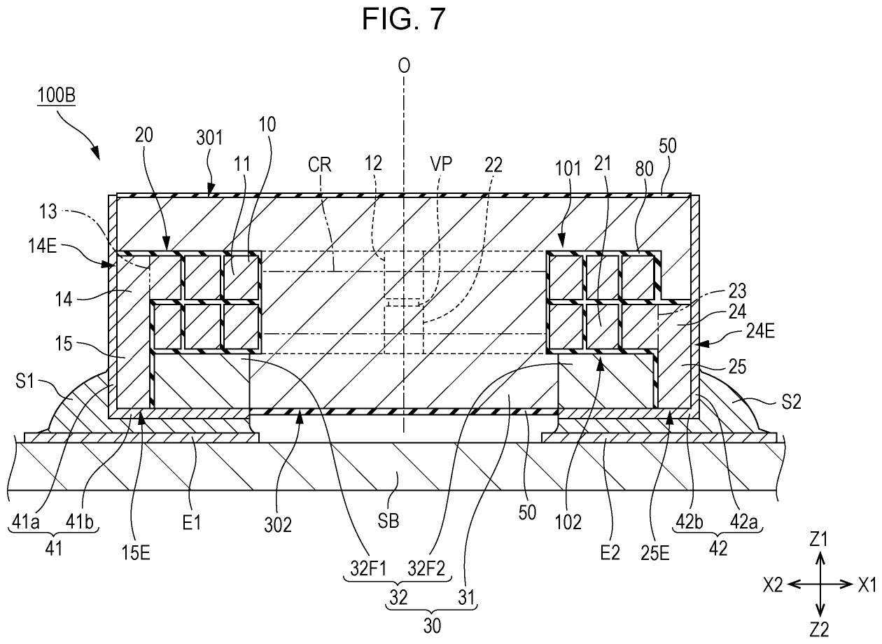

FIG. 8 is an XZ cross section illustrating a third variation of the coil component in an embodiment of the present invention. Basically, a coil component 100C, illustrated in FIG. 8, in one of the variations of an embodiment of the present invention has the same structure as the coil component 100. Therefore, only differences in the structure will be described, and descriptions of common points in the structure will be omitted. The ring-shaped conductor in the coil component 100 has been in contact with the second region 32 at the second end 102, which is an end on the same side as the second surface 302 in the first direction. In contrast, in the coil component 100C in this variation, the second end 102 of the ring-shaped conductor may be in contact with the first region 31.

That is, in the coil component 100C in this variation, the first region 31 extends in the first direction so as to come into contact with two ends (first end 101 and second end 102) of a portion, in the first direction, at which the ring-shaped conductor in the coil portion 10 is positioned. Specifically, the first region 31 is composed of a main portion 31C, which includes the first surface 301, is in contact with the first end 101, and includes the central region CR, and of an extending portion 31E, which is in contact with the second end 102 and extends in the X and Y directions. Thus, since all materials in contact with the ring-shaped conductor are the first material, it may be possible to stably enjoy advantages (such as suppression of a short-circuit in the coil portion 10 due to a local break of the insulating portion) obtained when the first region 31 is composed of the first material is provided.

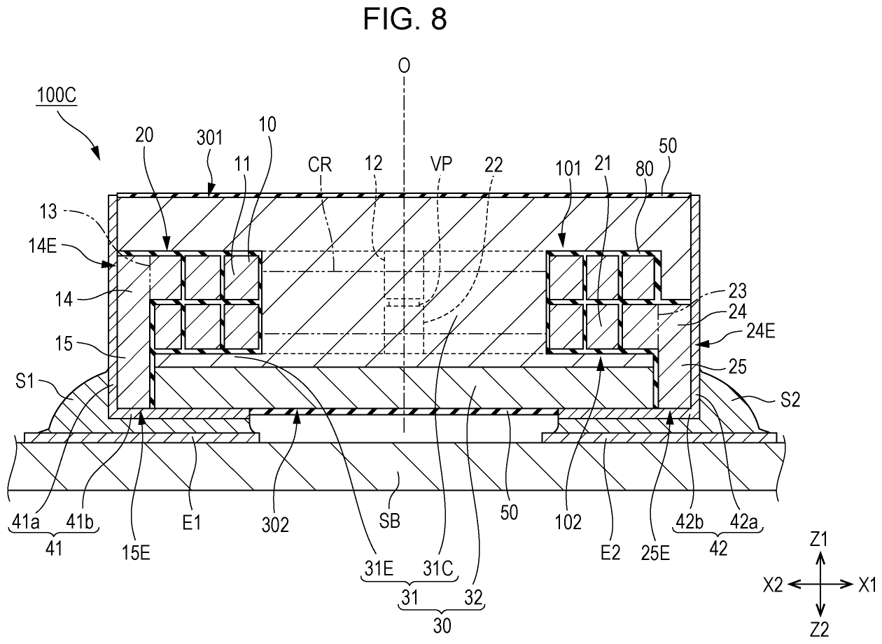

FIG. 9 is an XZ cross section illustrating a fourth variation of the coil component in an embodiment of the present invention. Basically, a coil component 100D, illustrated in FIG. 9, in one of the variations of an embodiment of the present invention has the same structure as the coil component 100. Therefore, only differences in the structure will be described, and descriptions of common points in the structure will be omitted. In the coil component 100D in this variation, the first outside electrode 41 lacks the first side-direction outer electrode 41a but is composed of only the first crossing-surface outer electrode 41b, and the second outside electrode 42 lacks the second side-direction outside electrode 42a but is composed of only the second crossing-surface outside electrode 42b. In the coil component 100D, an outer coat 61 is positioned in the portion where the first side-direction outer electrode 41a has been positioned, and an outer coat 62 is positioned in the portion where the second side-direction outside electrode 42a has been positioned.

Thus, in the coil component 100D, the first end of the coil portion 10 is composed of the first connection end 15E, the second end of the coil portion 10 is composed of the second connection end 25E, a portion that is electrically in contact with the first substrate electrode E1 and second substrate electrode E2 is positioned only on the mounting side (Z2 side in the Z1-Z2 direction). Therefore, on the substrate SB, on which the coil component 100D is mounted, the areas of the first substrate electrode E1 and second substrate electrode E2 can be reduced. Specifically, as for the first substrate electrode E1, a portion extending toward the X2 side in the X1-X2 direction can be shortened; and as for the second substrate electrode E2, a portion extending toward the X1 side in the X1-X2 direction can be shortened. That is, when the coil component 100D is used, the mounding density of parts mounted on the substrate SB can be increased.

### Method of Manufacturing the Coil Component

There is no particular restriction on a method of manufacturing the coil component in this embodiment. An unrestricted example of the manufacturing method will be described below.

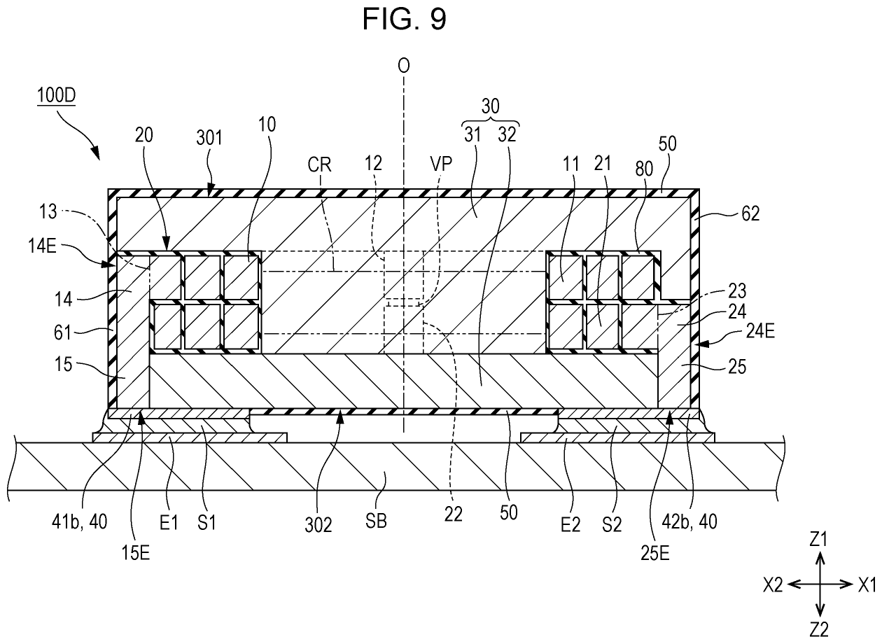

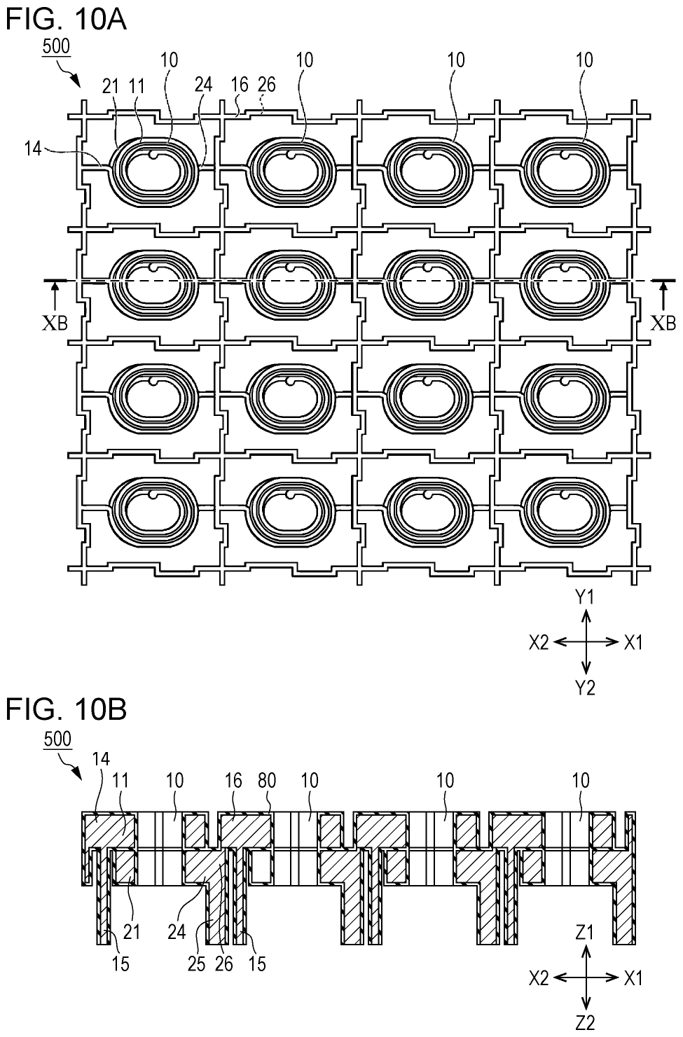

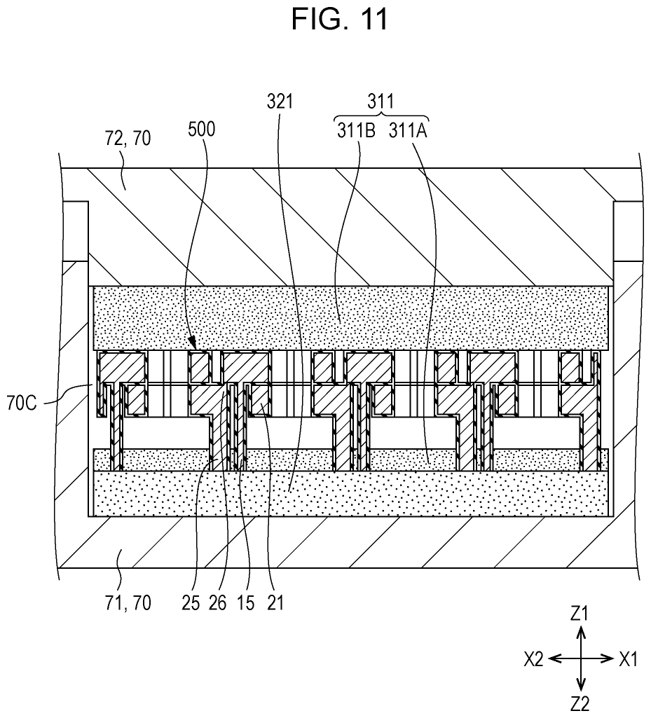

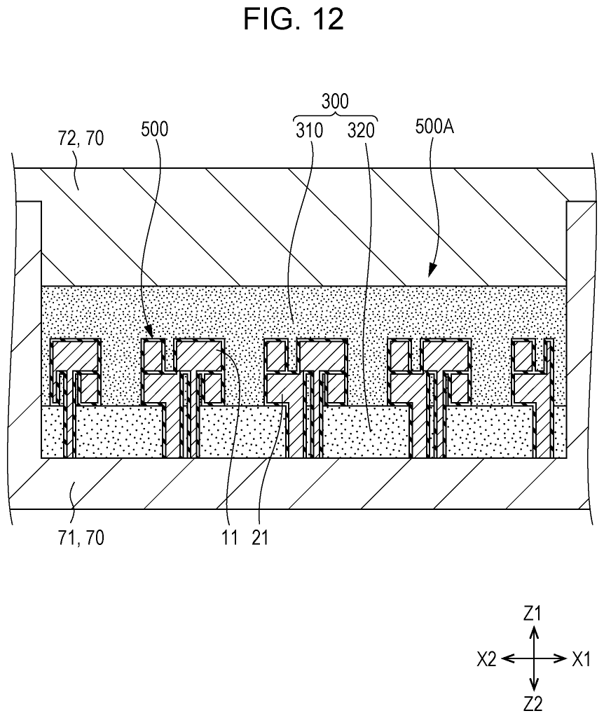

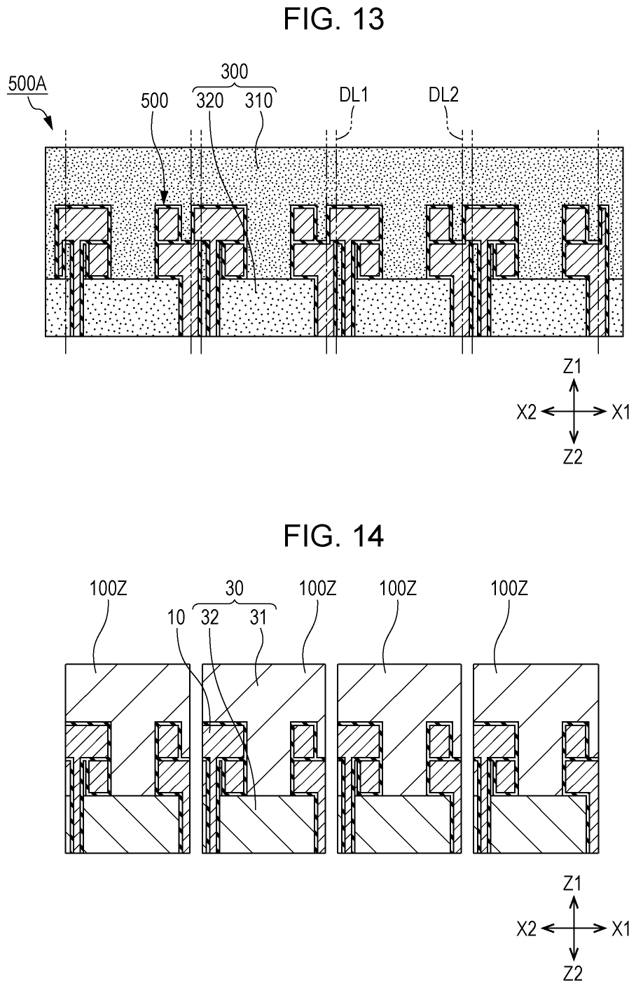

FIG. 10A illustrates a first example in an exemplary method of manufacturing the coil component in an embodiment of the present invention, as an XY plan view of a coil array sheet. FIG. 10B is an XZ sectional view along line XB-XB in FIG. 10A. FIG. 11 illustrates a second example in the exemplary method of manufacturing the coil component in an embodiment of the present invention, as an XZ sectional view illustrating a state in which the coil array sheet and the like are placed in the cavity. FIG. 12 illustrates a third example in the exemplary method of manufacturing the coil component in an embodiment of the present invention, as an XZ sectional view illustrating a state in which a press-molded body has been formed through press-molding in which a die was used. FIG. 13 illustrates a fourth example in the exemplary method of manufacturing the coil component in an embodiment of the present invention, specifically illustrating a state before the press-molded body is cut. FIG. 14 illustrates a fifth example in the exemplary method of manufacturing the coil component in an embodiment of the present invention, specifically illustrating a state in which coil chips have been obtained as a result of cutting the press-molded body.

First, a coil array sheet 500 is formed in which a plurality of coil portions 10, each of which includes the first swirl conductor 11, second swirl conductor 21, first lead 14, second lead 24, first connection conductor 15, and second connection conductor 25, are mutually linked through first link conductors 16 and second link conductors 26, as illustrated in the XY plan view in FIG. 10A and in the XZ cross section in FIG. 10B. Although there is no restriction on the manufacturing method, a plating process can be used as described below. Specifically, the process begins with forming a conductive sheet (seed layer) on both surfaces of an insulative sheet base material on the Z1 side and Z2 side in the Z1-Z2 direction. This is followed by electroplating processing to form conductors on the conductive layer as plated precipitates, each conductor including the first swirl conductor 11, second swirl conductor 21, first lead 14, second lead 24, first connection conductor 15, second connection conductor 25, first link conductor 16, and second link conductors 26, as illustrated in FIG. 10B.

There is no restriction on the method of forming the conductor. For example, an insulative-layer pattern, which is a negative pattern for a conductor, may be formed on a conductor layer on an insulative sheet base material, and electric plating processing in which a current is passed through the conductive layer may be performed to deposit plated precipitates on the conductive layer, which is exposed around the negative pattern, so that a conductor with a desired shape is formed. In this type of plating processing, vias VP can be formed by filling through-holes in the sheet base material with precipitates.

Then, at least part of the exposed portion of the sheet base material, on which the conductor has been formed, the exposed portion being not covered with the conductor in the Z1-Z2 direction, is removed. Specifically, the sheet base material is removed so that regions, each of which is enclosed by the inner edges of the first swirl conductor 11 and second swirl conductor 21, are included when viewed in the first direction (Z1-Z2 direction). When a negative pattern composed of an insulative layer is used in the conductor forming step as described above, the insulative layer is first removed, after which the conductive layer, which is exposed in the Z1-Z2 direction as a result of removing the insulative layer, is removed. In this way, a process is performed in which part of the sheet base material is exposed in the Z1-Z2 direction as an exposed portion and the exposed portion is then removed.

A specific process to remove the sheet base material is appropriately set according to the material from which to form the sheet base material. Removal processes are broadly classified into dry processes such as plasma etching and wet processes such as wet etching. After part of the sheet base material has been removed in the removal process, a residue, which has not been removed, may be present. For example, when the sheet base material is composed of a mixed material of a matrix portion formed from an organic material and an inorganic material dispersed in the matrix portion, the sheet base material may be removed in the removal process as a result of the removal of the matrix portion formed from an organic material.

Next, the coil insulating portion 80 is formed so as to cover the exposed surface of the conductor, forming the coil array sheet 500. The insulating portion of the coil array sheet 500 has a portion with both sides in the Z1-Z2 direction being covered with the conductor. In the manufacturing method described above, the portion is composed of the residue of the sheet base material rather than the coil insulating portion 80. In FIG. 10B, however, illustration of the portion is omitted and the portion is illustrated as part of the coil insulating portion 80.

A laminated body is then formed in a cavity 70C in a die 70, the laminated body being composed of the coil array sheet 500, obtained as described above, which includes a plurality of coil components 100, a first member 311, at least part of which is positioned on one side (Z1 side in the Z1-Z2 direction) of the coil array sheet 500 in the first direction, the first member 311 including first magnetic powder and a first curable/curing material, and a second member 321 positioned on another side (Z2 side in the Z1-Z2 direction) of the coil array sheet 500 in the first direction, the second member 321 including second magnetic powder and a second curable/curing material. Specifically, the laminated body is formed by placing the second member 321, one part 311A of the first member 311, the coil array sheet 500, and another part 311B of the first member 311 in that order from the same side (Z2 side in the Z1-Z2 direction) as a lower die 71 of the die 70 toward the same side (Z1 side in the Z1-Z2 direction) as an upper die 72 of the die 70, as illustrated in FIG. 11. Thus, the laminated body including the coil array sheet 500, first member 311, and second member 321 is placed in the cavity 70C in the die 70.

The first member 311 includes the first magnetic powder and first curable/curing material. After press-molding, the first member 311 becomes a first material body 310 formed from the first material, from which the first region 31 including the central region CR is formed. The second member 321 includes the second magnetic powder and second curable/curing material. After press-molding, the second member 321 becomes a second material body 320 formed from the second material, from which the second region 32 is formed.

As described above, in this description, the curable/curing material includes a material to be cured and a curing material (such as a polymerization initiator) that performs curing. Specifically, the curable/curing material includes compounds including active functional groups, such as a glycidyl group, an isocyanate group, and a carboxyl group, which easily react with other functional groups as well as compounds including functional groups having active hydrogen (such as a hydroxyl group and an amino group), which react with these active functional groups. Cross-linking substances including polyvalent ion, such as magnesium substances and calcium substances, are also categorized as curable/curing materials. When a curable/curing material is polymerized by a radical polymerization catalyst, a compound having ethylenically unsaturated bonds can be a curable/curing material. Polymerization catalysts that cause substances that perform the above polymerization reaction to start and continue the polymerization reaction are also categorized as curable/curing materials. Examples of the polymerization catalyst include urethane polymerization catalysts such as 2-(dimethylamino)-ethanol, epoxy polymerization catalysts such as tetrabutylphosphonium bromide, and olefin polymerization catalysts such as a metallocene compound.

The first member 311 and second member 321 may differ from each other in at least one property selected from the group consisting of properties (i) through (vi) listed below:
(i) Composition of the first magnetic powder and composition of the second magnetic powder;
(ii) Particle diameter distribution of the first magnetic powder and particle diameter distribution of the second magnetic powder;
(iii) Content of the first magnetic powder in the first member 311 and content of the second magnetic powder in the second member 321;
(iv) Composition of the first curable/curing material and composition of the second curable/curing material;
(v) Content of the first curable/curing material in the first member 311 and content of the second curable/curing material in the second member 321; and
(vi) Composition of a first additive component other than the first curable/curing material and first magnetic powder and composition of a second additive component other than the second curable/curing material and second magnetic powder if the first member 311 includes the first additive component and the second member 321 includes the second additive component.

Thus, differences can be made between the first material formed from the first member 311 and the second material formed from the second member 321, and differences can thereby be made between the property of the first region 31 and the property of the second region 32.

When press-molding including a process to increase pressure in the cavity 70 is performed for the laminated body obtained as described above, a press-molded body 500A having coil portions 10 and the main body 30 is obtained from the laminated body, as illustrated in FIG. 12. Specifically, the press-molded body 500A has the coil array sheet 500 including a plurality of coil portions 10, and also has a main body component 300, which forms the main body 30. In press-molding to obtain the press-molded body 500A from the laminated body, heating may be performed besides pressurization. If the degree of curing of the first curable/curing material included in the first member 311 is low, it may be possible to complete curing by, for example, heating, as described later.

Although the second member 321 and the one part 311A of the first member 311 are different from each other in the material, they may be integrated together by, for example, preheating. In this case, the laminated body can be easily placed in the cavity 70C in the die 70.

In the press-molding described above, a process to cure the first curable/curing material and second curable/curing material may be included. When this type of curing process is performed, the first member 311 and first material body 310 have different material properties and the second member 321 and second material body 320 also have different material properties. Therefore, the first member 311 and second member 321 can have individual functions from the viewpoint of press-molding.

A specific example of this type of individual function is to position the coil array sheet 500 in the die during the press-molding to obtain the press-molded body 500A. Specifically, when the first direction is along the vertical direction (Z1-Z2 direction) and the second member 321 is placed so as to be positioned below the coil array sheet 500 as illustrated in FIG. 11, it will be assumed that the second member 321 is harder than the first member 311. When a compressing force is exerted on the die 70 in the first direction, the coil array sheet 500 is easily buried in the first member 311, which is relatively soft, particularly in the interior of the one part 311A of the first member 311. However, the coil array sheet 500 is less likely to be buried in the second member 321, which is relatively hard. Thus, during the press-molding process, the bottom of the coil array sheet 500 on the lower side in the vertical direction (Z2 side in the Z1-Z2 direction) is stable in a state in which the bottom is in contact with the upper end of the second member 321. This can enhance precision with which the coil array sheet 500 in the press-molded body 500A is positioned in the vertical direction (first direction). Specifically, in the coil component 100, the distance between the second surface 302 and the end of the coil portion 10 on the Z2 side in the Z1-Z2 direction can be made to easily fall within an appropriate range.

In FIG. 11, in a state before the compressing force is exerted on the die 70 in the first direction, the tips of the first connection conductor 15, second connection conductor 25 and second link conductors 26, which protrude toward the lower side (Z2 side in the Z1-Z2 direction) in the cavity 70C in the die 70, are buried in the one part 311A of the first member 311, which is relatively soft, and are in contact with the end of the upper side (Z2 side in the Z1-Z2 direction) of the second member 321, which is relatively hard. When the upper die 72 is moved downward from this state to close the die, the tips of the first connection conductor 15, second connection conductor 25 and second link conductors 26 are buried in the second member 321. However, the lower side of the ring-shaped conductor, that is, the lower side of the second swirl conductor 21, remains in contact with the end of the upper side (Z2 side in the Z1-Z2 direction) of the second member 321. This portion assures precision with which the coil array sheet 500 is placed in the cavity 70C in the die 70.

After that, the first member 311 and second member 321 are cured and integrated together as illustrated in FIG. 12, forming the main body component 300 composed of the first material body 310 and second material body 320. Since the lower side of the second swirl conductor 21 is positioned at the boundary between the first material body 310 and second material body 320 constituting the main body component 300, precision with which the coil array sheet 500 is placed in the 500A is assured.

The first member 311 and second member 321 are in the so-called B-stage state. Before they are cured by being heated, they may be softened. In this case, the ring-shaped conductor is likely to be buried in the first member 311 while the first member 311 is soft. Similarly, the tips of the first connection conductor 15, second connection conductor 25 and second link conductors 26 are likely to be buried in the second member 321 while the second member 321 is soft. Even in this case, if the second member 321 is relatively harder than the first member 311, it is possible to keep the lower side of the second swirl conductor 21 in contact with the end of the upper side (Z2 side in the Z1-Z2 direction) of the second member 321, in spite of the softened state. When the curing of the first member 311 and second member 321 progress in this state, the tight contact between the first material body 310 and the second material body 320 is also improved, enabling the mechanical property and magnetic property of the main body component 300 to be easily assured.

The second member 321 may be made harder than the first member 311 by satisfying at least one of the conditions (I) through (VI):
(I) For the laminated body placed in the cavity 70C, the second curable/curing material has high viscosity than the first curable/curing material;
(II) For the laminated body placed in the cavity 70C, the second curable/curing material has a higher degree of polymerization than the first curable/curing material;
(III) For the laminated body placed in the cavity 70C, the content of an uncured material included in the second curable/curing material is less than the content of an uncured material included in the first curable/curing material;
(IV) For the laminated body placed in the cavity 70C, when the first curable/curing material and second curable/curing material each include a polymerization catalyst, the content of the polymerization catalyst included in the second curable/curing material is more than the content of the polymerization catalyst included in the first curable/curing material;
(V) For the laminated body placed in the cavity 70C, the second magnetic powder included in the second member 321 has a higher volume ratio than the first magnetic powder included in the first member 311; and
(VI) For the first curable/curing material and second curable/curing material included in the laminated body placed in the cavity 70C, gel time measured for the second curable/curing material is shorter than gel time measured for the first curable/curing material, the gel time being defined in JIS K5600-9-1:2006.

The second member 321 may be more insulative than the first member 311. In this case, the second material formed from the second member 321 can be made more insulative than the first material formed from the first member 311.

When the coil portion 10 has an insulating portion (coil insulating portion 80 and the like) that covers the surface of the ring-shaped conductor and the first magnetic powder includes metal magnetic powder as in this embodiment, it may be preferable to satisfy at least one of the condition (i) through (iv) below for a first member cross section obtained by cutting the first member 311 and a second member cross section obtained by cutting the second member 321:
(i) A first member average equivalent circle diameter, which is the average equivalent circle diameter of the first magnetic powder on the first member cross section, is smaller than a second member average equivalent circle diameter, which is the average equivalent circle diameter of the second magnetic powder on the second member cross section;
(ii) A first member median diameter, which is the median diameter of the first magnetic powder on the first member cross section, is smaller than a second member median diameter, which is the median diameter of the second magnetic powder on the second member cross section;
(iii) A first member maximum equivalent circle diameter, which is the maximum equivalent circle diameter of the first magnetic powder on the first member cross section, is smaller than a second member maximum equivalent circle diameter, which is the maximum equivalent circle diameter of the second magnetic powder on the second member cross section; and
(iv) At least one of a first member diameter distribution, which is a distribution of equivalent circle diameters of the first magnetic powder on the first member cross section, and a second member diameter distribution, which is a distribution of equivalent circle diameters of the second magnetic powder on the second member cross section, has two or more peaks, wherein a first member peak diameter, which is an equivalent circle diameter with the maximum frequency at the peak on the largest diameter side, the peak being one of the peaks included in the first member diameter distribution is smaller than a second member peak diameter, which is an equivalent circle diameter with the maximum frequency at the peak on the largest diameter side, the peak being one of the peaks included in the second member diameter distribution.

After the press-molded body 500A has been formed in the cavity 70C in the die 70, the press-molded body 500A is removed from the die 70 and is then cut along dicing lines DL1 and DL2 illustrated in FIG. 13. Thus, a coil chip 100Z having the coil portion 10 and the main body 30 composed of the first region 31 and second region 32 is obtained, as illustrated in FIG. 14. The outer coats 50 and 60 are then formed on the coil chip 100Z and the first outside electrode 41 and second outside electrode 42 are further formed, forming the coil component 100.

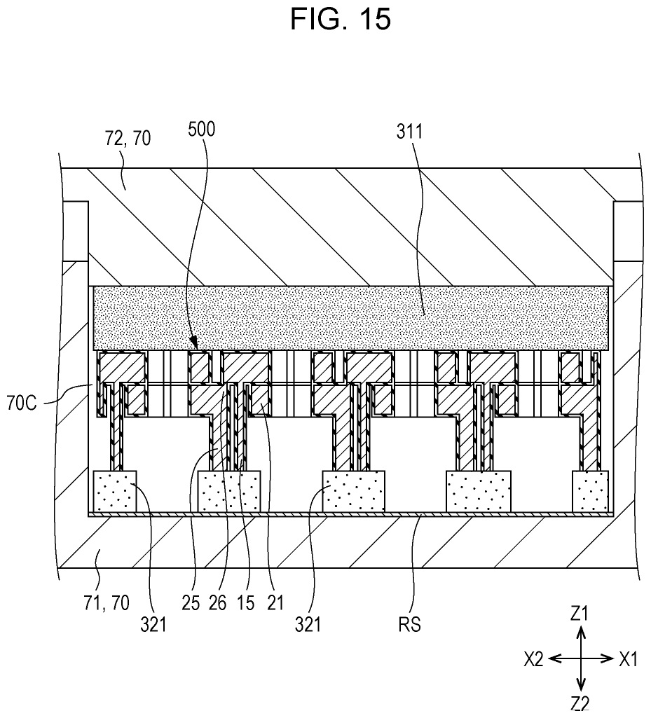

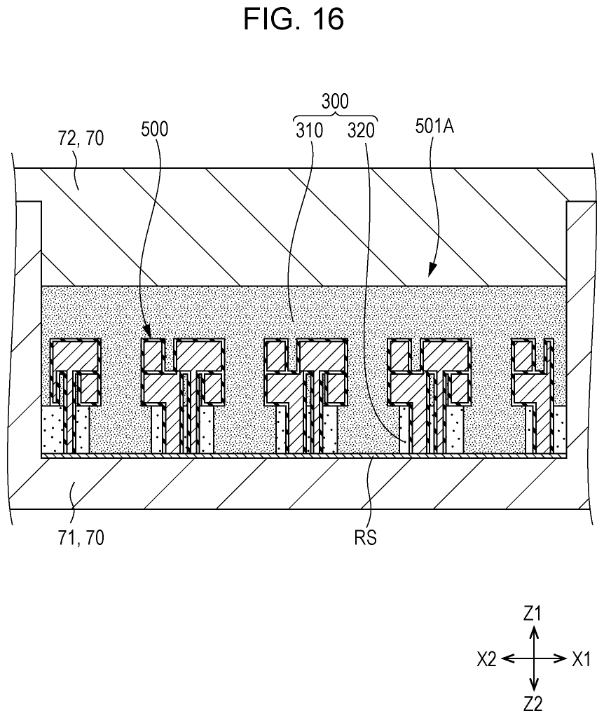

FIGS. 15 and 16 respectively illustrate a first example and second example of another exemplary method of manufacturing the coil component in an embodiment of the present invention. In these examples, the coil component 100B is manufactured. Basically, the manufacturing methods in these examples is the same as the example of the method of manufacturing the coil component 100 described above. Therefore, only differences in the structure or method will be described, and descriptions of common points in the structure and method will be omitted.

In the method of manufacturing the coil component 100B in these examples, in the coil component 100B, the first region 31 includes part of the second surface 302 of the main body 30. Therefore, the second member 321, which implements the second region 32, is present in discrete form on the bottom surface in the cavity 70C in the die 70, unlike in the method of manufacturing the coil component 100. Therefore, in the manufacturing method in these examples, a release member RS, on which the second member 321 is placed in discrete form, is placed on the button surface in the cavity 70C, and the coil array sheet 500 and first member 311 are placed on the second member 321, as illustrated in FIG. 15.

When the upper die 72 is moved downward from this state in the first direction to close the die and the first member 311 and second member 321 are then cured by heating or the like, a press-molded body 501A is obtained in which the second material body 320 is positioned in discrete form and the first material body 310 is present so as to be in contact with the outer circumference of each discrete portion of the second material body 320 in the X and Y directions, as illustrated in FIG. 16. Subsequently, when the manufacturing method is executed as in the method of manufacturing the press-molded body 500A, the coil component 100B is obtained.

### Electronic Device and Electric Device

An electronic device and electric device in an embodiment of the present invention are an electronic device and electric device in which the coil component 100, 100A, 100B, 100C, or 100D is mounted. In the electronic device and electric device, the coil component 100, 100A, 100B, 100C, or 100D is connected to the substrate SB through terminals (first outside electrode 41 and second outside electrode 42) provided on exposed conductors (first lead end 14E and second lead end 24E, for example), which are positioned at two ends of the coil portion 10, one at each end, so as to be exposed to the outside. Since the electronic device and electric device in an embodiment of the present invention each include the coil component 100, 100A, 100B, 100C, or 100D in an embodiment of the present invention, they can also be easily downsized. In particular, the coil component 100D can easily adapt to high-density mounting. Therefore, devices intended to include the coil component 100D is particularly easy to downsize. Even when a large current flows in the device or a high-frequency wave is applied to the device, a problem is less likely to occur, the problem being attributable to degradation of the property of the coil component 100, 100A, 100B, 100C, or 100D or heat generated from it.

Embodiments and examples have been described for easy understanding of the present invention and do not to limit the present invention. Therefore, each element disclosed in the above embodiments is intended to include all design changes and equivalents included in the technical range of the present invention.

1. A coil component, comprising:
a coil portion including:
a ring-shaped conductor formed of windings wound around a central axis extending in a first direction, the ring-shaped conductor having first and second electric ends; and
first and second connection conductors electrically connected to the first and second electric ends, respectively; and
a main body made of a material containing magnetic powder and a binder, the main body having surfaces including a first surface and a second surface on opposite sides thereof, in the first direction, the coil-portion being embedded in the main body between the first surface and the second surface with a first end face of the first connection conductor and a second end face of the second connection conductor exposed on the surfaces of the main body,
wherein the main body includes:
a first region and a central region formed of a first material, the first region including the first surface, and the central region being in contact with the first region and disposed in an interior space of the ring-shaped conductor such that an entire inner circumferential surface of the ring-shaped conductor is in contact with the central region, and
a second region formed of a second material, the second region including at least part of the second surface and being in contact with the first region,
and wherein the first material and the second material differ from each other in at least one property selected from the group consisting of:
a composition of the magnetic powder;
a shape distribution of a shape of the magnetic powder;
a content of the magnetic powder;
a composition of the binder;
a content of the binder; and
a composition and content of an optional third component, which is a component other than the magnetic powder and the binder.

2. The coil component according to claim 1, wherein the second material is more insulative than the first material.

3. The coil component according to claim 2, further comprising:
a first outside electrode provided on the main body, the first outside electrode being electrically connected to the first end face and including a first covering portion covering a part of the second surface; and
a second outside electrode provided on the main body distant from the first outside electrode, the second outside electrode being electrically connected to the second end face and including a second covering portion covering another part of the second surface,
wherein the second region has a first opposing portion facing the first covering portion and a second opposing portion facing the second covering portion.

4. The coil component according to claim 3, wherein:
the first end face includes a surface exposed on the second surface and in contact with the first covering portion; and
the second end face includes a surface exposed on the second surface and in contact with the second covering portion.

5. The coil component according to claim 3, wherein the second region has a contiguous surface which includes the at least part of the second surface, the first opposing portion, and the second opposing portion.

6. The coil component according to claim 2, wherein the second region has a specific resistance higher than the first region.

7. The coil component according to claim 2,
wherein the magnetic powder includes metal magnetic powder,
and wherein the second region has a relative permeability smaller than the first region.

8. The coil component according to claim 7, wherein a shortest distance between the second surface and the ring-shaped conductor in the first direction is greater than a shortest distance between the first surface and the ring-shaped conductor in the first direction.

9. The coil component according to claim 1, wherein the ring-shaped conductor is in contact with the second region at an end thereof in the first direction closest to the second surface.

10. A method of manufacturing a coil component including a coil portion and a main body having a first surface and a second surface between which the coil portion is embedded, the method comprising:
providing the coil portion including a ring-shaped conductor formed of windings wound around a central axis, the ring-shaped conductor having first and second electric ends;
placing a laminated body in a cavity in a die, the laminated body including:
the coil portion;
a first material member disposed on one side of the coil portion in a first direction which is a direction of the central axis, the first material member containing first magnetic powder and a first curing material; and
a second material member disposed on another side of the coil portion in the first direction, the second material member including second magnetic powder and a second curing material; and
pressurizing the cavity, thereby press-molding the laminated body into a press-molded body having the coil portion and the main body, such that the main body includes a central region formed from the first material member and disposed in an interior space of the ring-shaped conductor such that an entire inner circumferential surface of the ring-shaped conductor is in contact with the central region.

11. The method according to claim 10, wherein the first material member and the second material member differ from each other in at least one property selected from the group consisting of:
compositions of the first magnetic powder and the second magnetic powder;
particle diameter distributions of the first magnetic powder and the second magnetic powder;
contents of the first magnetic powder the second magnetic powder;
compositions of the first curing material and the second curing material;
contents of the first curing material and the second curing material; and
compositions of an optional first additive component and an optional second additive component, which are components other than the first and second curing materials and the first and second magnetic powders, optionally added to the first material member and the second material member, respectively.

12. The method according to claim 10, further comprising:
curing the first curing material and the second curing material after the pressurizing.

13. The method according to claim 12, wherein a material body formed from the second material member by the curing is more insulative than a material body formed from the first material member by the curing.

14. The method according to claim 13,
wherein the coil component further includes a first connection conductor and a second connection conductor connected to the first and second electric ends of the ring-shaped conductor, respectively,
and wherein, after the press-molding, portions of the first and second connection conductors are buried in the second material body such that a first end face of the first connection conductor and a second end face of the second connection conductor are exposed on the second surface of the main body in the press-molded body.

15. An electronic/electric device comprising:
a substrate; and
component according to claim 1, mounted on the substrate,
wherein the coil component is connected to the substrate through terminals connected to the first end face and the second end face exposed on the surfaces of the main body.
